(19) United States
(12) Patent Application Publication
(10) Pub. No.: US 2024/0390204 A1
(43) Pub. Date: Nov. 28, 2024

(54) Robotic Care Bed

(71) Applicant: ZUOLIANG CHEN, San Francisco, CA (US)

(72) Inventor: ZUOLIANG CHEN, San Francisco, CA (US)

(21) Appl. No.: 18/621,021

(22) Filed: Mar. 28, 2024

Related U.S. Application Data
(60) Provisional application No. 63/461,731, filed on Apr. 25, 2023.

(51) Int. Cl. A61G 7/16; A61G 5/00; A61G 5/04; A61G 5/10; A61G 5/12; A61G 7/018; A61G 7/02

(52) U.S. Cl. CPC A61G 7/165; A61G 5/006; A61G 5/04; A61G 5/1002; A61G 5/122; A61G 5/124; A61G 5/125; A61G 5/127; A61G 5/128; A61G 7/018; A61G 7/02

(57) ABSTRACT

A robotic care bed mainly comprises a bed body and a mobile body, the bed body comprises a stationary part and two rotatable sides that form an opening in the middle portion of the bed body to accommodate the mobile body, the mobile body can be automatically combined with or separated from the bed body by electromagnet devices, the mobile body has double plate high/low and turn over structure to perform the necessary high/low and turn over features, the mobile body can be automatically converted into a wheelchair that having features of auto armrest setup and auto charging, the two rotatable sides can be rotated sideward or upward to make rooms for the wheelchair to be set up and to move out or return to bed body opening easily, the mobile body also equipped with an auto bidet system.

### RELATED APPLICATION

This application claims priority from U.S. Provisional Patent Application No. 63/461,731, filed on Apr. 25, 2023, entitled Convertible Nursing System.

### FIELD OF THE INVENTION

The present invention is related to a robotic care bed that enables the elderly or disabled people to take care of themselves without assistance from caregivers. The robotic care bed mainly comprises a bed body and a mobile body, the bed body comprises a stationary part and two rotatable sides that form an opening in the middle portion of the bed body to accommodate the mobile body, the mobile body can be automatically combined with or separated from the bed body by electromagnet devices, the mobile body has double plate high/low and turn over structure to perform the necessary high/low and turn over features, the mobile body can be automatically converted into a wheelchair that having features of auto armrest and auto charging, the two rotatable sides can be rotated sideward or upward to make rooms for the armrests of the wheelchair to be set up automatically, and for the wheelchair to move out and return to bed body opening easily, the mobile body also equipped with an auto bidet system for easy defecation, urination and cleaning.

### BACKGROUND

We are entering an aging society, rising demand and short caregiver supply is a big problem faced by the elderly, disabled people (patients) and their family members. Generally, a patient's daily needs can be categorized as immediate needs and scheduled needs, immediate needs are those that cannot be arranged in advance and have to be met immediately, such as using toilet, cleaning after using toilet, turning over safely in bed, high/low in bed, out of bed activities, and returning to bed, usually a long-term caregiver is required to offer help to meet these immediate needs. Scheduled needs are those that can be arranged in advance, which is mainly to deal with various housework such as cleaning, laundry, cooking, assisting with bathing and massage, etc. usually such scheduled needs can be done by hourly caregivers, and long-term caregiver is not required.

So, we can see that if patients can meet their own immediate needs, long-term caregivers will not be required, and demand for caregivers can be reduced substantially. However, although there are many care equipment such as electric wheelchair, electric nursing bed, transfer machine etc. have been invented, these equipment can only help patients to meet only one or two of the above mentioned immediate needs instead of all of them, therefore long-term caregivers are still required to help patients to meet the other immediate needs, the purposes of these care equipments are to make job easier for caregivers rather than helping patients to take care of themselves and become independent.

Therefore, in order to help patients to regain their independence and reduce the need of caregivers, a robotic care bed that enables patients to meet all of the above mentioned immediate needs without any assistance from caregiver is very much desirable.

### ADVANTAGES OF PRESENT INVENTION

The present invention of robotic care bed enables patients to meet their immediate needs and regain their independence with the following features:
1. Auto bidet system to meet the immediate need of urination and defecation.
2. Auto washing, drying and odor sealing to meet the immediate need of cleaning after urination or defecation.
3. Auto shoulder line turn over to meet the immediate need of turn over safely in bed.
4. Auto high/low to meet the immediate need of high/low in bed.
5. Auto wheelchair conversion to meet the immediate need of out of bed activities.
6. Easy or auto returning to bed and auto charging to meet the immediate need of returning to bed.

### DESCRIPTION OF THE PRIOR ART

Many different types of robotic nursing beds have been invented, some of them can also be converted into a wheelchair, U.S. Pat. No. 9,295,596 “Combined Nursing Bed” invented by Hanzhong He, dated Mar. 29, 2016 disclosed a combined type nursing bed, the middle portion of the nursing bed can be converted into a wheelchair, this invention has the following shortcomings:
1. The wheelchair is not electric, a caregiver is required to set up the wheelchair, move it out and return to bed.
2. It has no turn over feature, the toilet has no cleaning means and the fecal bucket has no odor sealing.
3. It provides no means to lock the wheelchair to the bed body when combine the wheelchair to bed body to form a nursing bed, so it is unsecured and unsafe when used as a nursing bed.

CN102429795B “Care Robot” invented by inventor [symbol] , [symbol] and [symbol] , dated May 22, 2013 disclosed a nursing robot which can be converted into a wheelchair, this invention has the following shortcomings:
1. The whole bed is converted into a wheelchair, making it too big as a wheelchair, to small as a nursing bed.
2. Because the high/low and turn over features are performed by two sets of mechanical means, making the whole structure very complicated, bulky and heavy.
3. Turn over from the middle spine line, may cause potential injury to the patient and is unsafe.
4. When it is laid flat as a nursing bed, no sufficient support at the two ends, making the bed very unsecured and unsafe.

We can see that these prior inventions can only meet a few immediate needs instead of all of them, or unpractical, so they can't be used to solve the caregivers shortage problem.

In order to solve the defecation and urination problem, many different types of toilet or bidet system for nursing bed have been invented, however, these inventions have the following shortcomings:
1. They are usually too big to fit under a wheelchair seat, making it impossible to convert a nursing bed into a wheelchair.
2. Patients may not be able to position to the toilet hole properly, that will cause mess and lots of cleaning afterward.
3. Not able to automatically put a lid on the fecal bucket to prevent odor.
4. Because user have a weight on the toilet hole, such inventions may not be able to reposition the toilet seat back to toilet hole properly.
5. Patients can only defecate or urinate in bed, making their sleeping area smelly.

### BRIEF DESCRIPTION OF DRAWINGS

FIG. 1 illustrates the prospective view of robotic care bed.

FIG. 2 illustrates the top view of robotic care bed.

FIG. 3 illustrates the top view of bed body and mobile body.

FIG. 4 illustrates the front view of robotic care bed.

FIG. 5 illustrates the side view of robotic care bed.

FIG. 6 illustrates right and left rotatable sides rotate to the side, mobile body is converted into a wheelchair and move out.

FIG. 7 illustrates wheelchair return to bed body opening.

FIG. 8 illustrates wheelchair before automatic armrest is set up.

FIG. 9 illustrates wheelchair after automatic armrest is set up.

FIG. 10 illustrates the cross section side view of robotic care bed.

FIG. 11 illustrates the top view of mobile body (without mattress pads and armrest).

FIG. 12 illustrates the side view of mobile body in flat position (without mattress pads and armrest).

FIG. 13 illustrates the top view of back base plate.

FIG. 14 illustrates the top view of back turn plate.

FIG. 15 illustrates the rear view of back turn plate.

FIG. 16 illustrates the top view of back plate with back turn plate on top of back base plate.

FIG. 17 illustrates the front view of back plate.

FIG. 18 illustrates the side view of back plate.

FIG. 19 illustrates the top view of thigh base plate.

FIG. 20 illustrates the top view of thigh turn plate.

FIG. 21 illustrates the rear view of thigh turn plate.

FIG. 22 illustrates the top view of thigh plate with thigh turn plate on top of thigh base plate.

FIG. 23 illustrates the front view of thigh plate.

FIG. 24 illustrates the side view of thigh plate.

FIG. 25 illustrates the cross section front view of back plate connected to back plate high/low and turn over device.

FIG. 26 illustrates the cross section front view showing back turn plate is turned to the right side.

FIG. 27 illustrates the side view of mobile body showing both of back turn plate and thigh turn plate are turn to the right.

FIG. 28 illustrates the side view of mobile body converted into a wheelchair.

FIG. 29 illustrates the side view of converted wheelchair with thigh turn plate tilt backward.

FIG. 30 illustrates the side view of converted wheelchair with thigh turn plate tilt forward.

FIG. 31 illustrates the front view of robotic care bed with blanket blocking roller.

FIG. 32 illustrates the front view of robotic care bed with tilting side.

FIG. 33 illustrates the front view of bidet system.

FIG. 34 illustrates the side view of bidet system.

FIG. 35 illustrates the cross section front view of bidet system.

FIG. 36 illustrates the cross section side view of bidet system.

FIG. 37 illustrates the cross section side view of fecal bag holder ring.

FIG. 38 illustrates bidet seat is moved out of bidet hole.

FIG. 39 illustrates bidet seat turning to the side while fecal bag holder moving down.

FIG. 40 illustrates bidet seat turn to the side and fecal bag holder is moved down to its lowest position.

FIG. 41 illustrates bidet seat stay at the side and fecal bag holder move up to bidet hole to receive feces or urine.

FIG. 42 illustrates cleaning device move in to do the cleaning.

FIG. 43 illustrates that after cleaning, cleaning device retract, bidet seat stay at the side and fecal bag holder is moved down to its lowest position again.

FIG. 44 illustrates bidet seat turning upward and fecal bag holder moving up at the same time.

FIG. 45 illustrates bidet seat return to the bottom of bidet hole.

FIG. 46 illustrates bidet seat and fecal bag holder are moved up at the same pace to reposition.

FIG. 47 illustrates the front view of incontinence bidet system.

FIG. 48 illustrates the side view of incontinence bidet system.

FIG. 49 illustrates the cross section front view of incontinence bidet system.

FIG. 50 illustrates a fecal incontinence situation.

FIG. 51 illustrates fecal sensor detect the feces and then open fecal tube cover, and lower incontinence fecal bag holder.

FIG. 52 illustrates that after defecation, washing and drying device wash and dry the private part of patient and bidet seat pad.

FIG. 53 illustrates that after washing and drying, incontinence fecal bag holder is moved up and push incontinence bidet seat to reposition.

FIG. 54 illustrates the cross section side view of bed body with upward rotating sides and upward rotating device.

FIG. 55 illustrates the cross section side view of bed body with rotating sides rotate to an upright position and mobile body is converted into a wheelchair.

FIG. 56 illustrates the side view of robotic care bed with sideward moving sides.

FIG. 57 illustrates the top view of robotic care bed with sideward moving sides.

FIG. 58 illustrates the front view of urine guard.

FIG. 59 illustrates the side view of urine guard.

FIG. 60 illustrates the side view of urine guard installation.

Reference numerals in drawings

| | |
|---|---|
| 1 | Robotic care bed |
| 11 | Bed body |
| 111 | Stationary part |
| 1111 | Stationary head |
| 1112 | Right stationary side |
| 1113 | Left stationary side |
| 1114 | Inner stationary side liner actuator |
| 1115 | Outer stationary side liner actuator |
| 112 | Rotatable side |
| 1121 | Right rotatable side |
| 1122 | Left rotatable side |
| 1123 | Sideward hinge |
| 1124 | Rotatable side wheeled leg |
| 1125 | Sideward rotating device |
| 1126 | Upward hinge |
| 1127 | Rotatable side leg |
| 1128 | Upward rotating device |
| 113 | Side track |
| 114 | Bed body mattress pad |
| 12 | Control system |
| 13 | Auto charging device |
| 14 | Return guiding system |
| 141 | Return guiding rail |
| 142 | Return guiding laser pen |
| 1421 | Return guiding laser beam |
| 2 | Mobile body |
| 21 | Wheelchair |
| 211 | Mobile body wheel |
| 22 | Rechargeable battery |
| 23 | Mobile body mattress pad |
| 24 | Plate hinge |
| 25 | Rotatable armrest |
| 251 | Armrest rotatable arm |
| 252 | Armrest bar |
| 253 | Armrest rotating device |
| 254 | Armrest lock |
| 255 | Armrest locking piece |
| 26 | Mobile body chamber |
| 27 | Calf and feet plate high/low device |
| 271 | Calf plate linear actuator |
| 2711 | Calf plate joint swivel |
| 272 | Feet plate linear actuator |
| 2721 | Feet plate joint swivel |
| 2722 | Feet plate linkage |
| 28 | Blanket blocking roller |
| 281 | Roller spring |
| 282 | Roller fabric |
| 3 | Back plate |
| 31 | Back base plate |
| 311 | Back base plate window |
| 3121 | Right back base plate electromagnet |
| 3122 | Left back base plate electromagnet |
| 32 | Back turn plate |
| 3211 | Right back turn plate |
| 3212 | Left back turn plate |
| 3221 | Right center back turn plate |
| 3222 | Left center back turn plate |
| 3231 | Right back turn plate magnet locking piece |
| 3232 | Left back turn plate magnet locking piece |
| 324 | Back turn plate hinge |
| 33 | Back plate linear actuator |
| 331 | Right back plate linear actuator |
| 332 | Left back plate linear actuator |
| 34 | Back plate bottom multi direction joint swivel |
| 35 | Back plate top multi direction joint swivel |
| 36 | Back plate linear actuator base |
| 37 | Back plate magnet locking piece |
| 38 | Back plate electromagnet |
| 39 | Back plate high/low and turn over device |
| 4 | Thigh plate |
| 41 | Thigh base plate |
| 411 | Thigh base plate window |
| 4121 | Right thigh base plate electromagnet |
| 4122 | Left thigh base plate electromagnet |
| 42 | Thigh turn plate |
| 4211 | Right thigh turn plate |
| 4212 | Left thigh turn plate |
| 4221 | Right Center thigh turn plate |
| 4222 | Left Center thigh turn plate |
| 4231 | Right thigh turn plate magnet locking piece |
| 4232 | Left thigh turn plate magnet locking piece |
| 424 | Thigh turn plate hinge |
| 43 | Thigh plate linear actuator |
| 431 | Right thigh plate linear actuator |
| 432 | Left thigh plate linear actuator |
| 44 | Thigh plate bottom multi direction joint swivel |
| 45 | Thigh plate top multi direction joint swivel |
| 46 | Thigh plate linear actuator base |
| 47 | Bidet hole |
| 48 | Thigh plate high/low and turn over device |
| 49 | Thigh plate mattress pad |
| 5 | Calf plate |
| 51 | Calf plate magnet locking piece |
| 52 | Calf plate electromagnet |
| 6 | Feet plate |
| 61 | Feet plate magnet locking piece |
| 62 | Feet plate electromagnet |
| 7 | Bidet system |
| 71 | Bidet seat |
| 711 | Bidet seat plate |
| 712 | Bidet seat screw jack |
| 713 | Bidet seat turning device |
| 714 | Bidet seat pad |
| 72 | Fecal bag holder |
| 721 | Fecal bag holder ring |
| 7211 | Fecal bag holder ring mounting groove |
| 7212 | Fecal bag holder ring water guard |
| 7213 | Cleaning tube opening |
| 73 | Fecal bag holder Screw jack |
| 731 | Fecal bag holder screw jack motor |
| 74 | Fecal bag |
| 741 | Fecal bag tray |
| 75 | Cleaning device |
| 76 | Water tank |
| 8 | Incontinence bidet system |
| 81 | Incontinence bidet seat |
| 811 | Incontinence bidet seat plate |
| 812 | Incontinence bidet seat pad |
| 813 | Incontinence fecal hole |
| 82 | Inner incontinence fecal bag holder |
| 821 | Fecal tube |
| 822 | Fecal tube cover |
| 823 | Fecal tube cover opening device |
| 824 | Fecal sensor |
| 825 | Inner incontinence fecal bag |
| 826 | Inner incontinence fecal bag fastener |
| 827 | Inner incontinence fecal bag holder Screw jack |
| 8271 | Inner incontinence fecal bag holder screw jack motor |
| 83 | Outer incontinence fecal bag holder |
| 831 | Outer incontinence fecal bag |
| 832 | Outer incontinence fecal bag fastener |
| 84 | Fecal bag tray |
| 85 | Incontinence cleaning device |
| 86 | Incontinence water tank |
| 87 | Butt retainer |
| 871 | Retainer fabric |
| 872 | Retainer bottom opening |
| 873 | Retainer fastener |
| 874 | Retainer cleaning hole |
| 9 | Urine guard |
| 91 | Bottom urine blocking plate |
| 92 | Top urine blocking plate |
| 93 | Stem |

### DETAILED DESCRIPTION OF PREFERRED EMBODIMENT

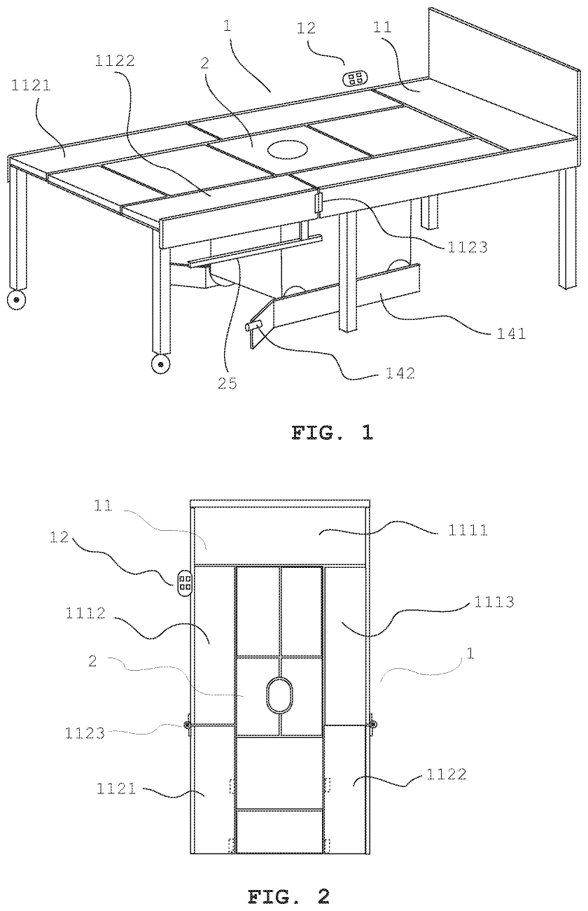

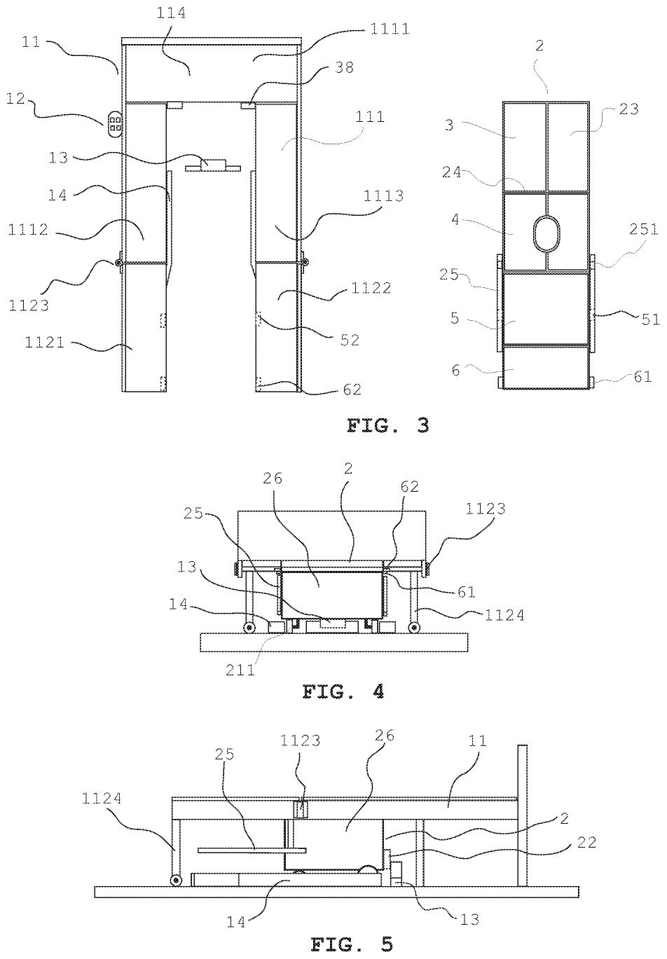

FIG. 1 illustrates the prospective view of robotic care bed 1, FIG. 2 illustrates the top view of robotic care bed 1, FIG. 3 illustrates the top view of bed body 11 and mobile body 2 of robotic care bed 1, FIG. 4 illustrates the front view of robotic care bed 1, FIG. 5 illustrates the side view of robotic care bed 1.

As illustrated in FIG. 1, FIG. 2, FIG. 3, FIG. 4 and FIG. 5, robotic care bed 1 of the present invention comprises a bed body 11, a mobile body 2, and a control system 12, bed body 11 further comprises a stationary part 111, a right rotatable side 1121, a left rotatable side 1122, an auto charging device 13, and a return guiding system 14, stationary part 111 further comprises a stationary head 1111, a right stationary side 1112, and a left stationary side 1113.

As illustrated in FIG. 3, FIG. 4 and FIG. 5, one end of right rotatable side 1121 is jointed to right stationary side 1112 with a first sideward hinge 1123, another end of right rotatable side has a first wheeled leg 1124, and can be rotated to the right by a first sideward rotating device 1125 (not shown), one end of left rotatable side 1122 is jointed to left stationary side 1113 with a second sideward hinge 1123, another end of left rotatable side 1122 has a second wheeled leg 1124, and can be rotated to the left by a second sideward rotating device 1125 (not shown), stationary part 111, right rotatable side 1121 and left rotatable side 1122 form an bed body opening in the middle portion of bed body 11 to accommodate mobile body 2, mobile body 2 can be automatically combined with or separated from bed body 11 by electromagnet means, control system 12 is connected to robotic care bed 1 via wired or wireless means and is capable of receiving orders from a person and instruct robotic care bed 1 to act accordingly, auto charging device 13 is capable of automatically charging mobile body 2 when it is returned to bed body opening, return guiding system 14 is capable of guiding wheelchair 21 return to bed body opening easily, bed body 11 is covered with bed body mattress pad 114.

Mobile body 2 is the most important part of the present invention, it can be automatically converted into a wheelchair 21, it has a double plate high/low and turn over structure, an auto bidet system, an auto armrest system, and auto charging.

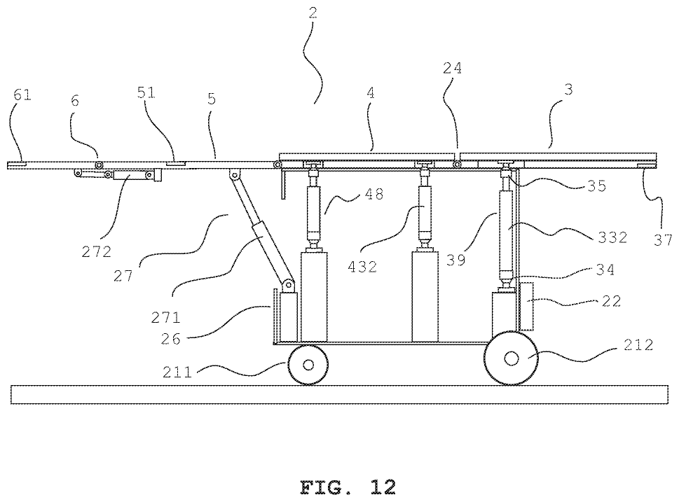

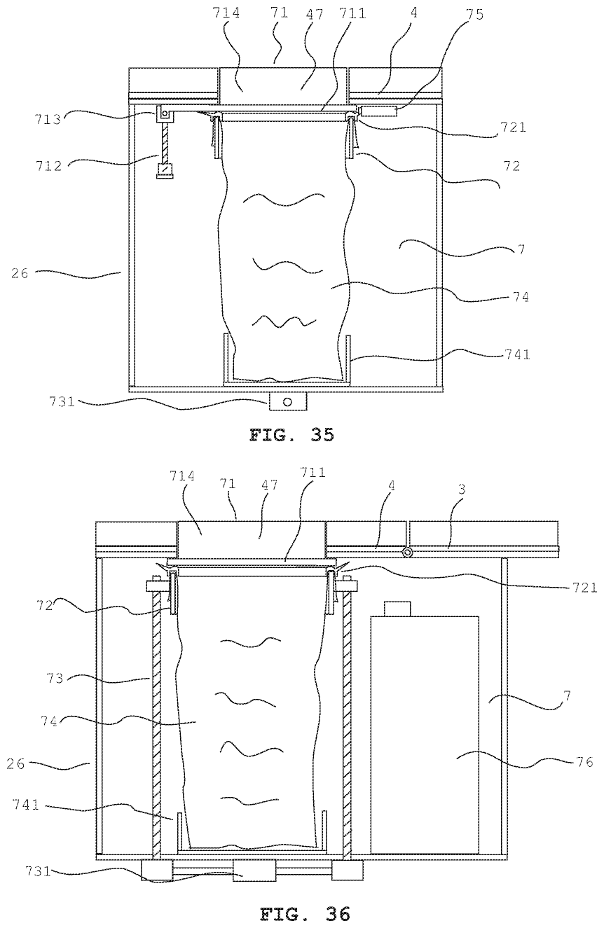

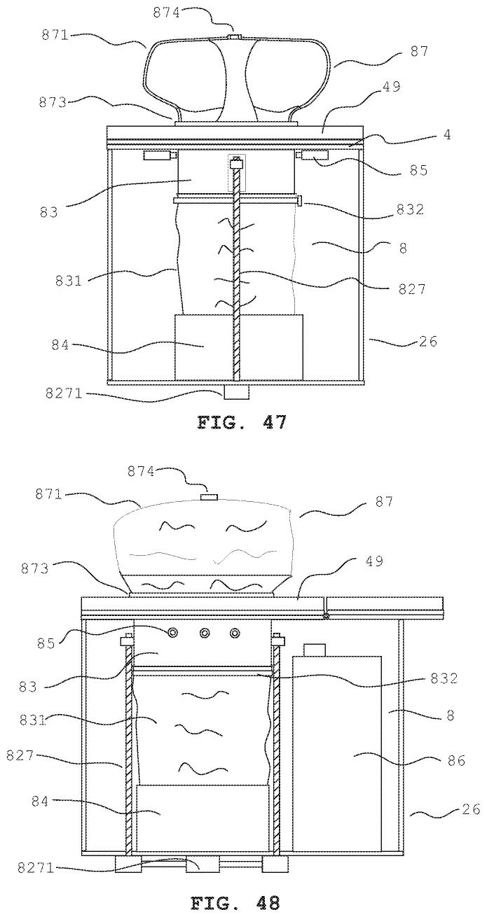

As illustrated in FIG. 3, FIG. 4, FIG. 5, FIG. 11 and FIG. 12, mobile body 2 comprises a back plate 3, a thigh plate 4, a calf plate 5, a feet plate 6, a back plate high/low and turn over device 39, a thigh plate high/low and turn over device 48, a calf and feet plate high/low device 27, a mobile body chamber 26, an auto bidet system 7 (shown in FIG. 35) or an incontinence bidet system 8 (shown in FIG. 47), four mobile body wheels 211, and a rechargeable battery 22; the bottom edge of back plate 3 is jointed to the top edge of thigh plate 4 with a first plate hinge 24, the bottom edge of thigh plate 4 is jointed to the top edge of calf plate 5 with a second plate hinge 24, the bottom edge of calf plate 5 is jointed to the top edge of feet plate 6 with a third plate hinge 24, back plate 3 is operated by back plate high/low and turn over device 39, thigh plate 4 is operated by thigh plate high/low and turn over device 48, both calf plate 5 and feet plate 6 are operated by calf and feet plate high/low device 27, thigh plate 4 is mounted on top of mobile body chamber 26, a bidet hole 47 is opened in the middle portion of thigh plate 4 and chamber 26 to accommodate the bidet seat of bidet system 7 or incontinence bidet system 8, back plate high/low and turn over device 39, thigh plate high/low and turn over device 48, and bidet system 7 are housed in mobile body chamber 26, mobile body chamber 26 is mounted on mobile body wheels 211, rechargeable battery 22 is mounted in mobile body chamber 26 and provides power to all the electric parts in mobile body 2, mobile body 2 is covered with mobile body mattress pad 23, when two of mobile body wheels 211 are replaced by electric motor wheels 212, mobile body 2 can be driven by electric power.

FIG. 6 illustrates right rotatable side 1121 and left rotatable side 1122 are rotated to the side, mobile body 2 is converted into wheelchair 21 and move out of bed body opening.

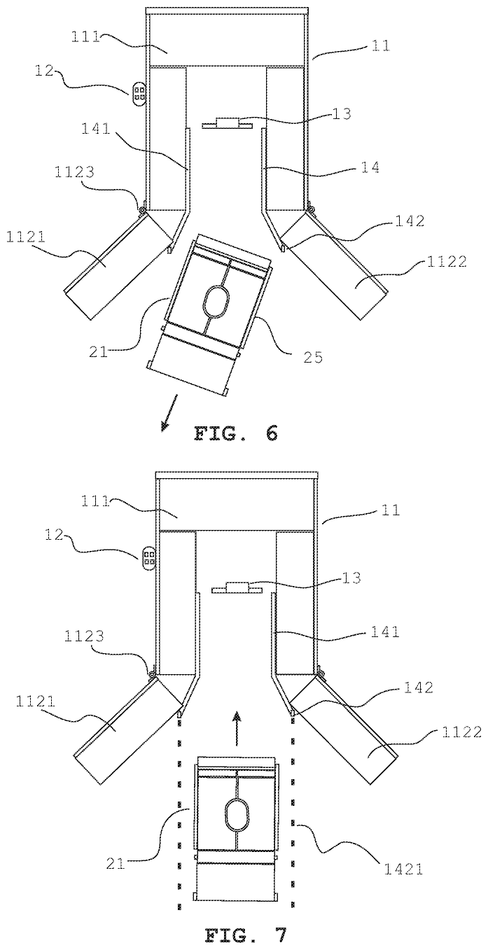

FIG. 7 illustrates wheelchair 21 use return guiding system 14 to return to bed body opening, return guiding system 14 comprises a return guiding rail 141 and two return guiding laser pens 142, return guiding rail 141 is installed along bed body opening and has a wide open entrance, each side of the entrance is affixed with a return guiding laser pen 142, return guiding laser pens 142 can generates visible laser beams 1421 to indicate the location of return rail entrance to a wheelchair user, such that wheelchair user can follow laser beams 1421 to return to bed body opening easily.

Armrest is very important for the safety of wheelchair user, since a patient who use robotic care bed 1 is unable to setup armrest manually when mobile body 2 is converted to wheelchair 21, the present invention provides a method to set up armrest automatically.

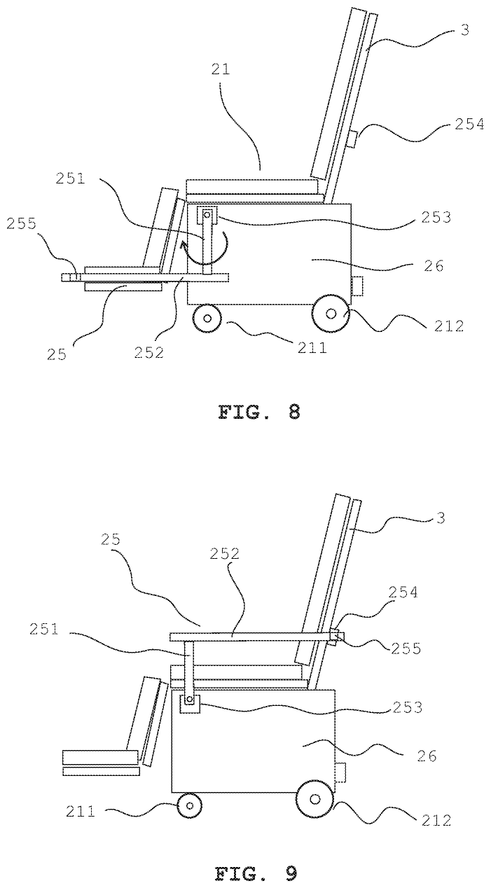

As illustrated in FIG. 8 and FIG. 9, a first rotatable armrest 25 is mounted on the right side of mobile body chamber 26, a second rotatable armrest 25 is mounted on the left side of mobile body chamber 26, rotatable armrest 25 comprises a rotatable arm 251, an armrest bar 252, and an armrest rotating device 253, one end of rotatable arm 251 is connected to armrest bar 252 perpendicularly, another end is connected to armrest rotating device 253, armrest rotating device 253 is installed on the side of mobile body chamber 26, an armrest locking piece 255 is affixed to the long end of armrest bar 252, an armrest lock 254 is affixed to the edge of base plate 3, in a location corresponding to armrest locking piece 255, when mobile body 2 is laid flat, armrest bar 252 is held under thigh plate 4 by armrest rotatable arm 251, when mobile body 2 is converted into wheelchair 21, rotatable arm 251 is rotated 180 degree upward by armrest rotating device 253, making armrest bar 252 rotate 180 degree upward to a position level with thigh plate 4, and armrest locking piece 255 is rotated to the location of armrest lock 254, such that armrest locking piece 255 is locked with armrest lock 254, such that armrest 25 are automatically secured to wheelchair 21, armrest lock 254 can be electromagnet lock or mechanical lock.

In order for rotatable armrest to be set up automatically, sideward hinges 1123 must be positioned closer to stationary head 1111 than armrest rotatable arms 251, such that when right rotatable sides 1121 and left rotatable side 1122 are rotated to the side, armrest rotatable arm 251 has room to be rotated upward to setup armrest 25 automatically.

As we can see from FIG. 1, FIG. 2 and FIG. 3, bed body 11 and mobile body 2 are two separated parts, they are locked together to form robotic care bed 1, in other inventions, there is no such locking or the locking is manually done with mechanical means, that means caregiver is required to manually lock or unlock mobile body 2 with bed body 11. The present invention use electromagnet means to do the locking and unlocking automatically.

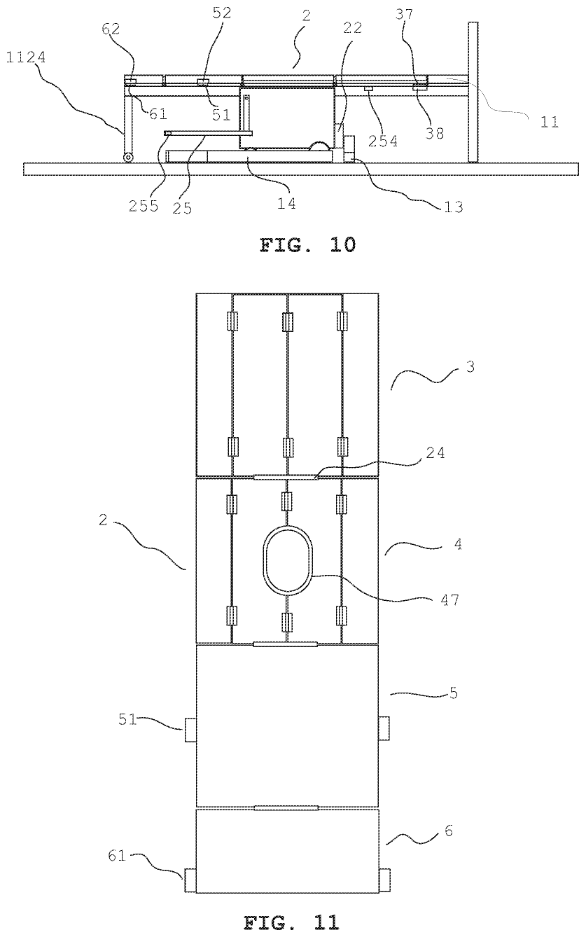

As illustrated in FIG. 1, FIG. 2, FIG. 3, FIG. 10 and FIG. 11, in bed body 11, at least one back plate electromagnet 38 is affixed to the inner edge of stationary head 1111, a first calf plate electromagnet 52 is affixed to the inner edge of right rotatable side 1121, a second calf plate electromagnet 52 is affixed to the inner edge of left rotatable side 1122, a first feet plate electromagnet 62 is affixed to the inner edge of right rotatable side 1121, a second feet plate electromagnet 62 is affixed to the inner edge of left rotatable side 1122.

In mobile body 2, there is at least one back plate magnet locking piece 37 is affixed to the edge of back plate 3, in location corresponding to back plate electromagnet 38, such that when mobile body 2 is laid flat, back plate 3 move downward, causing back plate magnet locking piece 37 move to the location of back plate electromagnet 38, when back plate electromagnet 38 is electrified, back plate magnet locking piece 37 is locked with back plate electromagnet 38, making back plate 3 to be locked with bed body 11.

In mobile body 2, there is a first calf plate magnet locking piece 51 affixed to the right edge of calf plate 5, in location corresponding to first calf plate electromagnet 52, there is a second calf plate magnet locking piece 51 affixed to the left edge of calf plate 5, in location corresponding to second calf plate electromagnet 52, there is a first feet plate magnet locking piece 61 affixed to the right edge of feet plate 6, in location corresponding to first feet plate electromagnet 62, there is a second feet plate magnet locking piece 61 affixed to the left edge of feet plate 6, in location corresponding to second feet plate electromagnet 62, such that when mobile body 2 is laid flat, calf plate 5 and feet plate 6 move upward, causing calf plate magnet locking piece 51 and feet plate magnet locking piece 61 move to the locations of calf plate electromagnet 52 and feet plate electromagnet 62, when calf plate electromagnet 52 and feet plate electromagnet 62 are electrified, calf plate magnet locking piece 51 is locked with calf plate electromagnet 52, and feet plate magnet locking piece 61 is locked with feet plate electromagnet 62, making calf plate 5 and feet plate 6 to be locked with rotating side 112, such that mobile body 2 can be locked with bed body 11 automatically.

The high/low and turn over feature of a nursing bed is very important for patients, traditional nursing beds use a single plate structure for this feature, since they have to use one set of mechanism for high/low, and use another set of mechanism for turning over, that makes the nursing bed structure very complicated and bulky, and not suitable for converting into a wheelchair, also, because of the mechanical limitation, current nursing bed can only turn over around the middle line of a nursing bed, since people actually turn over around their shoulder instead of around their spine, the traditional turn over method having many problems such as small turning angle, uncomfortable turning, unable to turn over, potential injury, etc.

Unlike traditional nursing bed that use a single plate structure, the present invention use a double plate structure, in which back plat 3 is constructed with a base plate 31 and a turn plate 32, thigh plate 4 is constructed with a base plate 41 and a turn plate 42, the whole or part of turn plate can be combined together or separated from base plate by electromagnet means, both high/low feature and turn over feature are performed by the same back plate high/low and turn over device 39 and thigh plate high/low and turn over device 48, such that mobile body 2 can be easily switched from high/low feature to turn over feature by combining turn plates with base plates or separating turn plates with base plats.

FIG. 13 illustrates the top view of back base plate 31, a right back base plate electromagnet 3121 is affixed to the right side of back base plate 31, a left back base plate electromagnet 3122 is affixed to the left side of back base plate 31, a back base plate window 311 is located on back base plate 31.

FIG. 14 illustrates the top view of back turn plate 32, back turn plate 32 comprises a right back turn plate 3211, a left back turn plate 3212, a right center back turn plate 3221, a left center back turn plate 3222, they are jointed together by a plurality of back turn plate hinges 324.

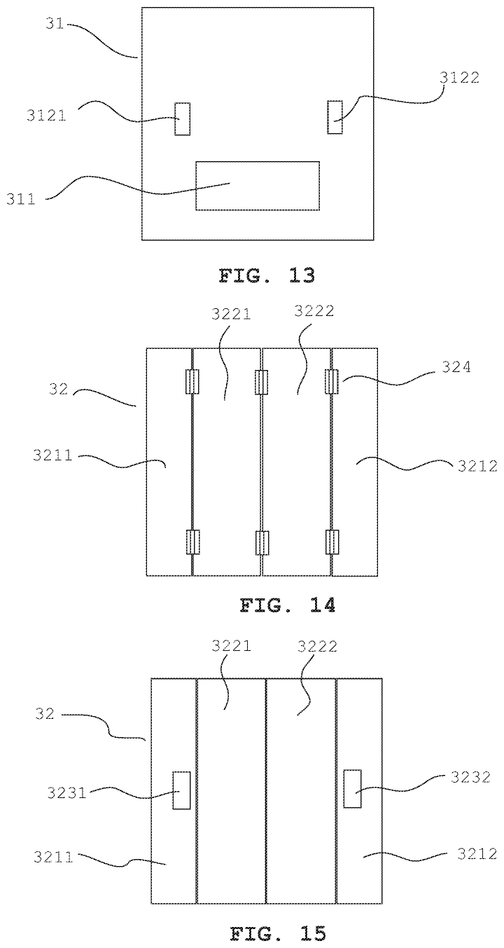

FIG. 15 illustrates the rear view of back turn plate 32, a right back turn plate magnet locking piece 3231 is affixed to the rear of right back turn plate 3211, in a location corresponding to right back base plate electromagnet 3121, a left back turn plate magnet locking piece 3232 is affixed to the rear of left back turn plate 3212, in a location corresponding to left back base plate electromagnet 3122.

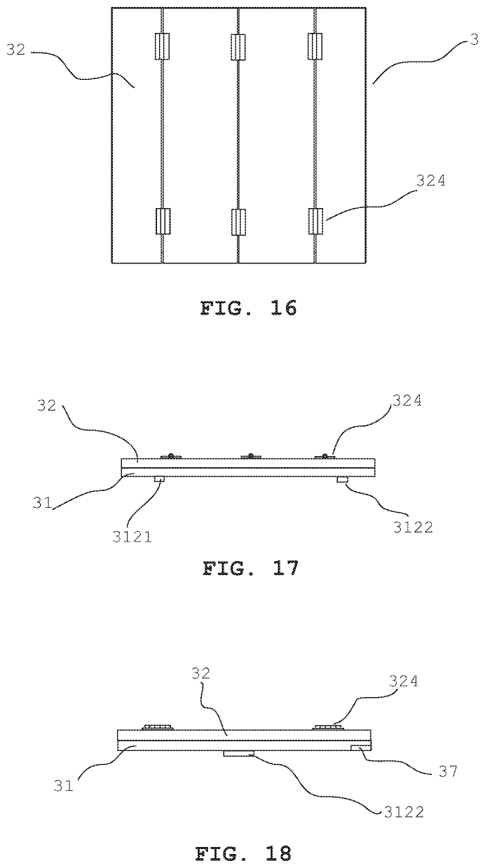

FIG. 16 illustrates the top view of back plate 3, FIG. 17 illustrates the front view of back plate 3, FIG. 18 illustrates the side view of back plate 3, in which back turn plate 32 is placed on top of back base plate 31, with right back turn plate magnet locking piece 3231 locate above right back turn plate electromagnet 3121, and with left back turn plate magnet locking piece 3232 locate above left back turn plate electromagnet 3122.

FIG. 19 illustrates the top view of thigh base plate 41, in which a right thigh base plate electromagnet 4121 is affixed to the right side of thigh base plate 41, a left thigh base plate electromagnet 4122 is affixed to the left side of thigh base plate 41, four thigh base plate windows 411 are located on thigh base plate 41; a bidet seat hole 47 is located in the middle portion of thigh base pale 41.

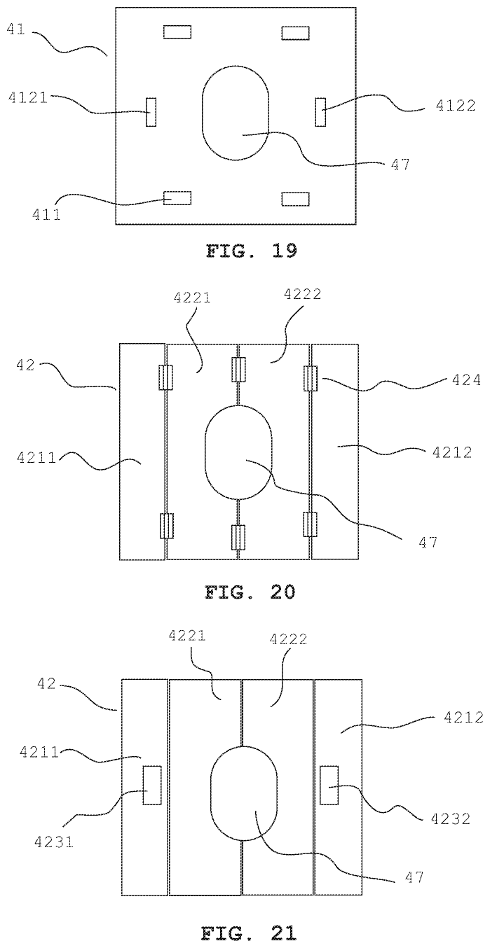

FIG. 20 illustrates the top view of thigh turn plate 42, thigh turn plate 42 comprises a right thigh turn plate 4211, a left thigh turn plate 4212, a right center thigh turn plate 4221, a left center thigh turn plate 4222, they are jointed together by a plurality of thigh turn plate hinges 424, a bidet hole 47 is located in the middle portion of thigh turn pale 42.

FIG. 21 illustrates the rear view of thigh turn plate 42, a right thigh turn plate magnet locking piece 4231 is affixed to the rear of right thigh turn plate 4211, in a location corresponding to right thigh base plate electromagnet 4121, a left thigh turn plate magnet locking piece 4232 is affixed to the rear of left thigh turn plate 4212, in a location corresponding to left thigh base plate electromagnet 4122.

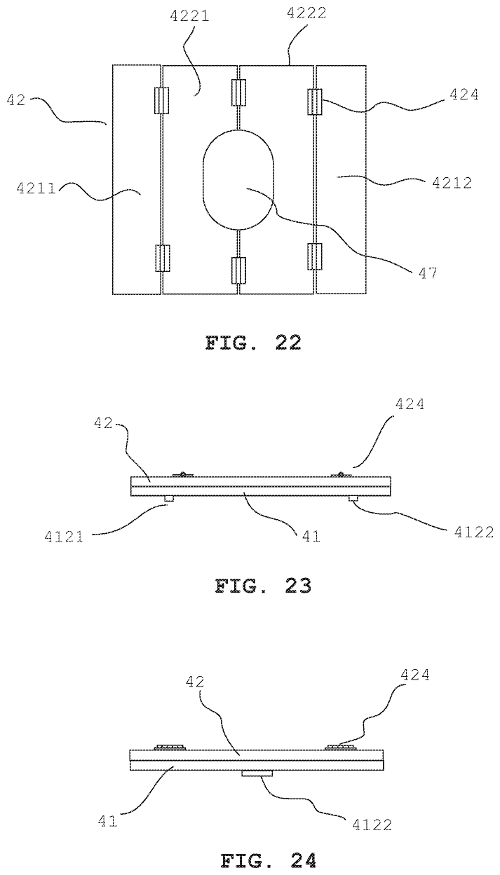

FIG. 22 illustrates the top view of thigh plate 4, FIG. 23 illustrates the front view of thigh plate 4, FIG. 24 illustrates the side view of thigh plate 4, in which thigh turn plate 42 is placed on top of thigh base plate 41, with right thigh turn plate magnet locking piece 4231 locate above right thigh turn plate electromagnet 4121, and left thigh turn plate magnet locking piece 4232 locate above left thigh turn plate electromagnet 4122.

FIG. 25 illustrates the cross section front view of back plate 3 and back plate high/low and turn over device 39, in which back plate 3 is in a flat position.

As illustrated in FIG. 25, back plate high/low and turn over device 39 comprises a right back plate linear actuator 331, a left back plate linear actuator 332, two bottom multi direction joint swivels 34, two top multi direction joint swivels 35, and two back plate linear actuator base 36.

As illustrated in FIG. 25, the bottom of right back plate linear actuator 331 is affixed to a first back plate linear actuator base 36 via a first bottom multi direction joint swivel 34, the extension tube of right back plate linear actuator 331 is extended through back base plate window 311 and affixed to the rear of right center turn plate 3221 via a first top multi direction joint swivel 35, the bottom of left back plate linear actuator 332 is affixed to a second back plate linear actuator base 36 via a second bottom multi direction joint swivel 34, the extension tube of left back plate linear actuator 332 is extended through back base plate window 311 and affixed to the rear of left center turn plate 3222 via a second top multi direction joint swivel 35, when right back base plate electromagnet 3121 is electrified, it will lock with right back turn plate magnet locking piece 3231, when left back base plate electromagnet 3122 is electrified, it will lock with left back turn plate magnet locking piece 3232, such that back turn plate 32 is combined with back base plate 31 into one piece when right back base plate electromagnet 3121 and left back base plate electromagnet 3122 are electrified.

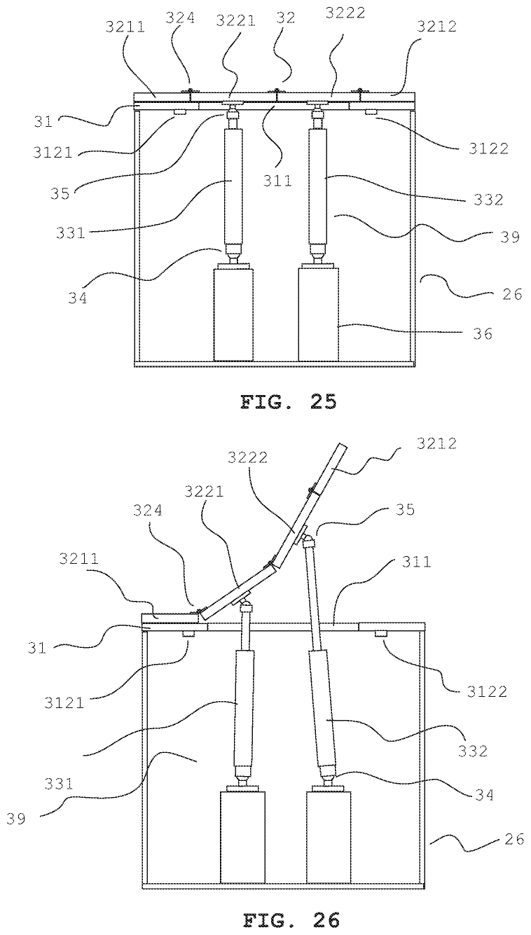

FIG. 26 illustrates how back turn plate 32 turn over to the right, before turn over, back plate 3 should be laid flat with bed body 11, right back base plate electromagnet 3121 and left back base plate electromagnet 3122 are electrified, back plate electromagnet 38 is also electrified, such that back plate 3 is combined with bed body 11, when control system 12 receives an order to turn over to the right, left back base plate electromagnet 3122 is unelectrified, cause left back turn plate magnet locking piece 3232 to be unlocked from left back base plate electromagnet 3122, such that left back turn plate 3212 is released from back base plate 31, at the same time, controlled by a preset program, left back plate linear actuator 332 extend at a fast speed to a long distance, and right back linear actuator 331 extend at a slow speed to a short distance, making the left portion of back turn plate 32 to turn around back turn plate hinge 324 that join right back turn plate 3211 and right back center plate 3221 to a desired angle, since left center turn plate 3222 and right center turn plate 3221 are joined by turn plate hinge 324, so that the turn over angle and curve can be adjusted by adjusting the extended distance of right back linear actuator 331 and left back linear actuator 332, such that the turn over of robotic care bed 1 can be adjusted to match the upper and lower body shape of a particular patient for safe and comfortable turn over.

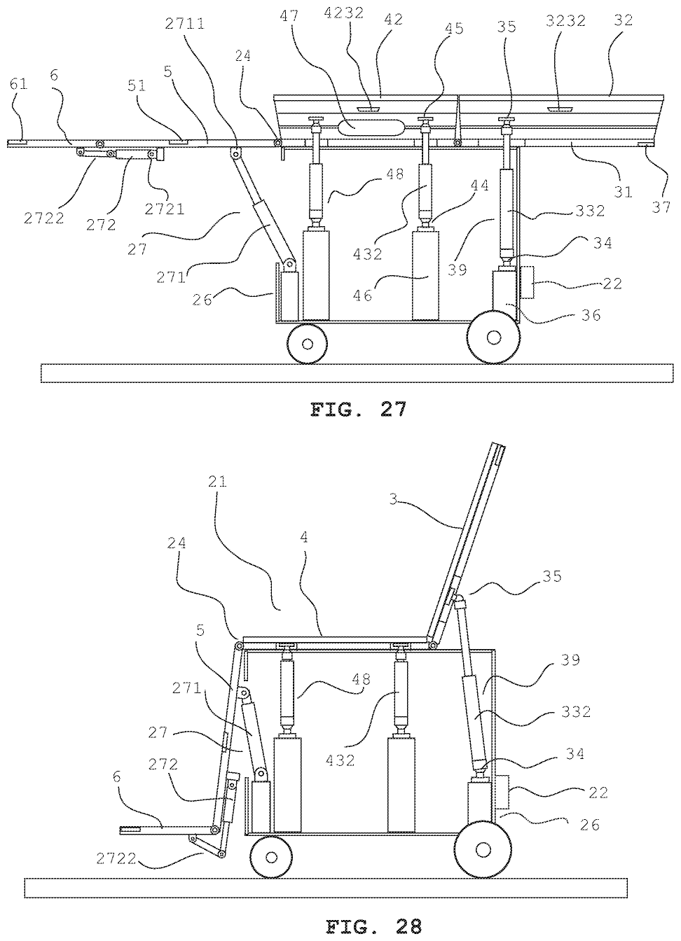

FIG. 27 illustrates the side view of mobile body 2, showing both back turn plate 32 and thigh turn plate 42 are turn over to the right.

As illustrated in FIG. 27, thigh plate high/low and turn over device 48 comprises two right thigh plate linear actuator 431 (not shown), two left thigh plate linear actuator 432, four bottom multi direction joint swivels 44, four top multi direction joint swivels 45, and four thigh plate linear actuator base 46, the connection of thigh plate high/low and turn over device 48 to thigh turn plate 42 is similar to that of back plate high/low and turn over device 39 to back turn plate 32.

As illustrated in FIG. 27, the turn over method of thigh turn plate 42 is similar to that of back turn plate 32, and done by two right thigh liner actuators 431 and two left thigh linear actuators 432, in the present invention, back turn plate 32 and thigh turn plate 42 are independent from each other, so that they can be turn to different angle and curve to better conform to a particular patient's upper body and lower body shape.

FIG. 28 illustrates how mobile body 2 is converted into wheelchair 21, when back plate 3 is raised by back plate high/low and turn over device 39, calf plate 5 and feet plate 6 are lowered by calf and feet plate high/low device 27, mobile body 2 is converted into wheelchair 21.

As illustrated in FIG. 28, when back plate 3 need to be raised up, first back turn plate 32 must be locked with back base plate 31 into one piece, then back plate magnet locking piece 37 is unlocked from back plate electromagnet 38, making back plate 3 unlocked from stationary part 111, such that when right back plate linear actuator 331 and left back plate linear actuator 332 extend at the same speed, base plate 3 will rotate around plate hinge 225 that connect back base plate 31 and thigh base plate 41 to a desired angle.

To convert mobile body 2 into a wheelchair, calf plate 5 and feet plate 6 must be lowered, traditional high/low method require linear actuators to be installed inside mobile body chamber 26 and a long linkage is needed, this method will occupy valuable space in the mobile body chamber 26, and the strength may not be strong enough.

The present invention provides a new method to solve this problem, as illustrated in FIG. 27 and FIG. 28, calf plate and feet plate high/low device 27 comprises a calf plate linear actuator 271, two calf plate joint swivels 2711, a feet plate linear actuator 272, two feet plate joint swivel 2721, and a feet plate linkage 2722, the base of calf plate linear actuator 271 is affixed to the front part of mobile body cabinet 26 with a first calf plate joint swivel 2711, the extension tube of calf plate linear actuator 271 is affixed to the rear of calf plate with a second calf plate joint swivel 2711, the base of feet plate linear actuator 272 is affixed to the rear of calf plate 5 with first feet plate joint swivel 2721, the extension tube of feet plate linear actuator 272 is affixed to the rear of feet plate 6 with a second feet plate joint swivel 2721 and feet plate linkage 2722, such that the high/low of calf and feet plates can be controlled by the extend distance of calf plate linear actuator 271 and feet plate linear actuator 272.

Urination and defecation is always a big problem for patients, some nursing beds do equip with commode to solve this problem, however, such commode has the following problems:
1. Patients have to urinate or defecate in bed, due to the commode lack of any odor seal, that will make the sleeping area very smelly.
2. It is difficult for patients to position to the commode hole correctly, that will cause mess and lots of cleaning afterward.

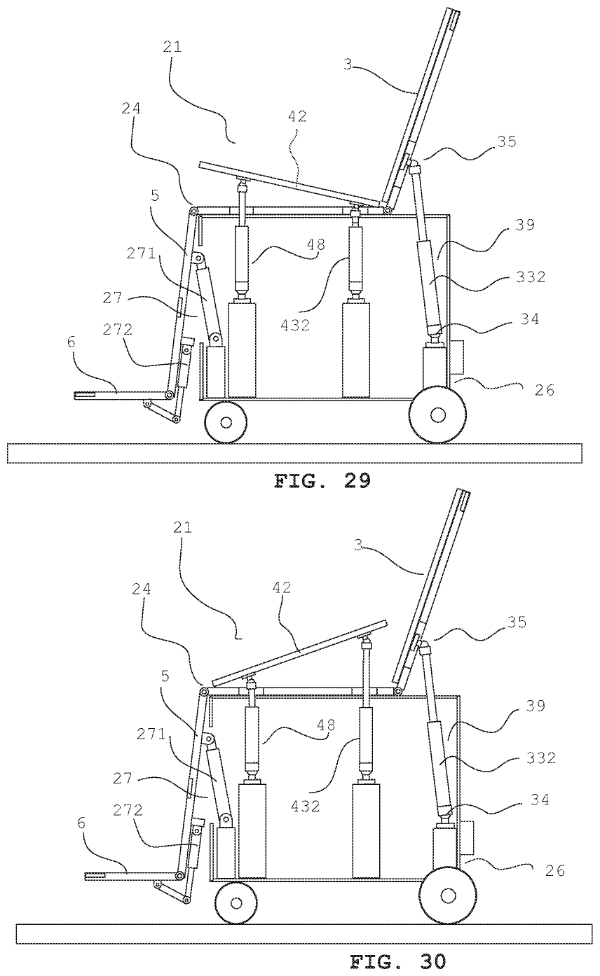

The present invention solve this problem by converting mobile body 2 into a bidet wheelchair with special positioning feature, as illustrated in FIG. 29, when control system 12 receives an order to use the bidet system, mobile body 2 is automatically converted into wheelchair 21, patient is retained in the seat of wheelchair 21, also, when mobile body 2 begin to be converted into wheelchair 21, right thigh base plate electromagnet 4121 and left thigh base plate electromagnet 4122 are unelectrified, thigh turn plate 42 is unlocked from thigh base plate 41, thigh plate linear actuators 43 in the front extend a long distance, thigh plate linear actuators 43 in the rear extend a short distance, such that thigh turn plate is tilted backward to a certain degrees, such that patient can be positioned properly to bidet hole 47 to avoid mess, patient can use wheelchair 21 go to any spot that is more suitable for urination or defecation.

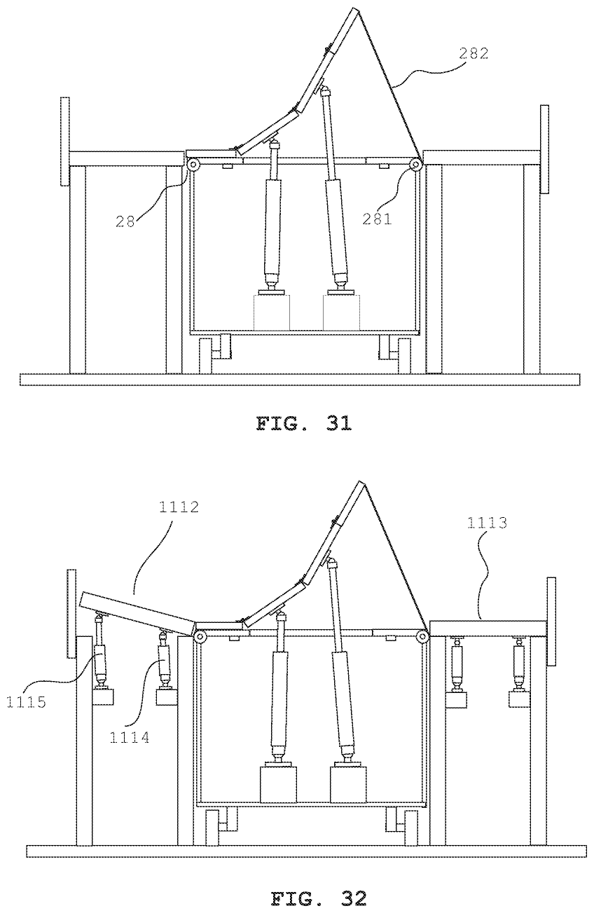

Many patients have difficulty stand up from wheelchair, the present invention provide a solution to this problem, as illustrated in FIG. 30, when mobile body 2 is converted to wheelchair 21 and control system receives an order to help patient to stand up, right thigh base plate electromagnet 4121 and left thigh base plate electromagnet 4122 are unelectrified, thigh turn plate 42 is unlocked from thigh base plate 41, thigh plate linear actuators 43 in the front extend a short distance, thigh plate linear actuators 43 in the rear extend a long distance, such that thigh turn plate is tilted forward to a certain degrees to help patient to stand up more easily.

In the present invention, when turn plates are turned to the right or left, an opening between base plates and turn plates is created, this allows blanket to fall into the opening and cause turn plate not able to reposition properly, to solve this problem, as illustrated in FIG. 31, a plurality of blanket blocking rollers 28 are used to cover the opening, blanket blocking roller 28 comprises a roller spring 281 and a roller fabric 282, roller spring 281 is affixed to the edge of base plate, one end of roller fabric 282 is affixed to the side edge of turn plate, another end of roller fabric 282 is affixed to roller spring 281, such that when all robotic care bed 1 is not in turn over mode, roller fabric 282 is rolled into roller spring 281, when turn plate is turn to the right or left, roller fabric 282 is pulled out of roller spring 281 by turn plate, creating a shield to cover the opening between base plate and turn plate to prevent blanket from falling into the opening.

When robotic care bed 1 turn over to the right or left, patients may slide to the side of robotic care bed 1, to prevent this and make sure patient is always stay in the middle portion of robotic care bed 1, as illustrated in FIG. 32, right stationary side 1112 is supported and operated by a first inner stationary side liner actuator 1114 and a first outer stationary side liner actuator 1115, in which first inner stationary side liner actuator 1114 is affixed to the rear of inner edge of right stationary side 1112 via a joint swivel, first outer stationary side liner actuator 1115 is affixed to the rear of outer edge of right stationary side 1112 via a joint swivel; left stationary side 1113 is supported and operated by a second inner stationary side liner actuator 1114 and a second outer stationary side liner actuator 1115, in which second inner stationary side liner actuator 1114 is affixed to the rear of inner edge of left stationary side 1113 via a joint swivel, second outer stationary side liner actuator 1115 is affixed to the rear of outer edge of left stationary side 1113 via a joint swivel, such that when turn plate turn to the right, first inner stationary side liner actuator 1114 is extended a very short distance, and first outer stationary side liner actuator 1115 is extended a longer distance, making right stationary side 1112 to tilt toward the middle of robotic care bed 1, thus prevent patient from sliding to the right side, it works the same way when robotic care bed 1 turn over to the left.

Defecation and urination is always a big problem for patients, traditional method to solve this problem is to use bed pans or manual commode, this method requires lots of assistance from caregiver and is very unpleasant, in view of this, many automatic commode systems for nursing bed are invented, however, such automatic commode systems still have many shortcomings such as not easy for patients to position correctly to commode hole in bed, too big to fit under a wheelchair, not able to automatically put a lid on the feces bucket to prevent odor, not able to reposition commode seat properly, because patients who use the commode put a weight on the commode seat hole, making the commode seat is hard to be repositioned properly unless sufficient pushing force is applied.

The present invention provides solutions to these problems.

There are two types of patients, one is fecal continence patient, another type is fecal incontinence patient, in view of this, the present invention provides two auto bidet systems, one is bidet system 7 for fecal continence patients, another one is incontinence bidet system 8 for fecal incontinence patients.

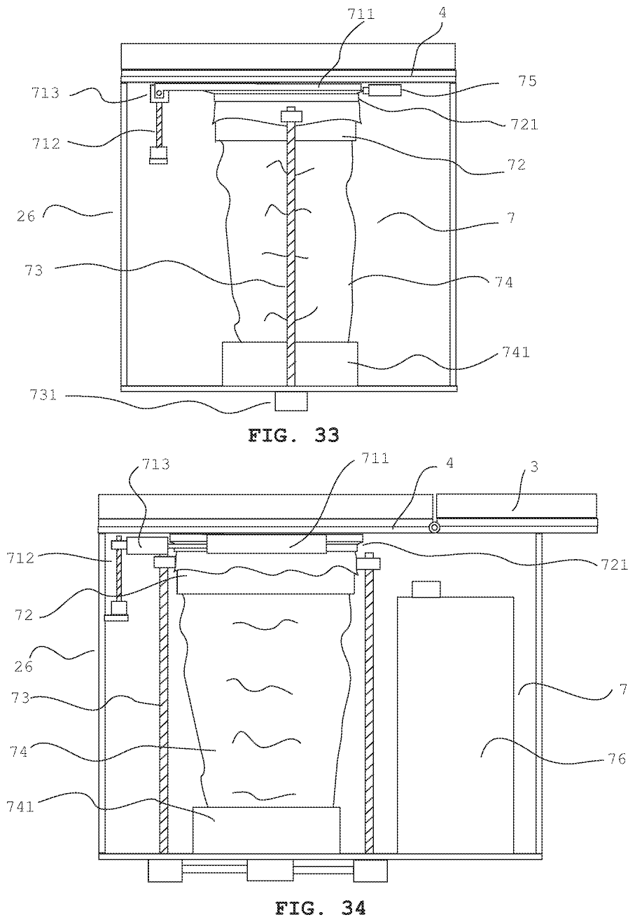

FIG. 33 illustrates the rear view of bidet system 7, FIG. 34 illustrates the side view of bidet system 7, FIG. 35 illustrates the cross section rear view of bidet system 7, FIG. 36 illustrates the cross section side view of bidet system 7, bidet system 7 comprises a bidet seat 71, a fecal bag holder 72, a fecal bag holder screw jack 73, a fecal bag 74, a cleaning device 75, and a water tank 76.

As illustrated in FIG. 33, FIG. 34, FIG. 35 and FIG. 36, bidet seat 71 further comprises a bidet seat plate 711, a bidet seat screw jack 712, a bidet seat turning device 713, and a bidet seat pad 714, bidet seat pad 714 has a thickness and is attached to the top of bidet seat plate 711, bidet seat pad 714 is positioned in bidet hole 47 when bidet system 7 is in ready to use mode, one end of bidet seat plate 711 is connected to bidet seat turning device 713, such that bidet seat 71 can be turned by bidet seat turning device 713, bidet seat turning device 713 is mounted on bidet seat screw jack 712 and can be moved up or down by bidet seat screw jack 712, fecal bag holder 72 is mounted on fecal bag holder screw jack 73, and is positioned right under bidet hole 47 and can be moved up or down by fecal bag holder screw jack 73, fecal bag holder screw jack 73 is driven by fecal bag holder screw jack motor 731, fecal bag 74 is a flexible plastic bag and can be attached to or removed from fecal bag holder 72 by fecal bag holder ring 721, fecal bag 74 is supported by fecal bag tray 742, cleaning device 75 has an extendable washing tube and an extendable drying tube that provide the needed washing and drying for patient's private part after defecation or urination, washing device 75 is connect to water tank 76 via water tube and get water supply from water tank 76.

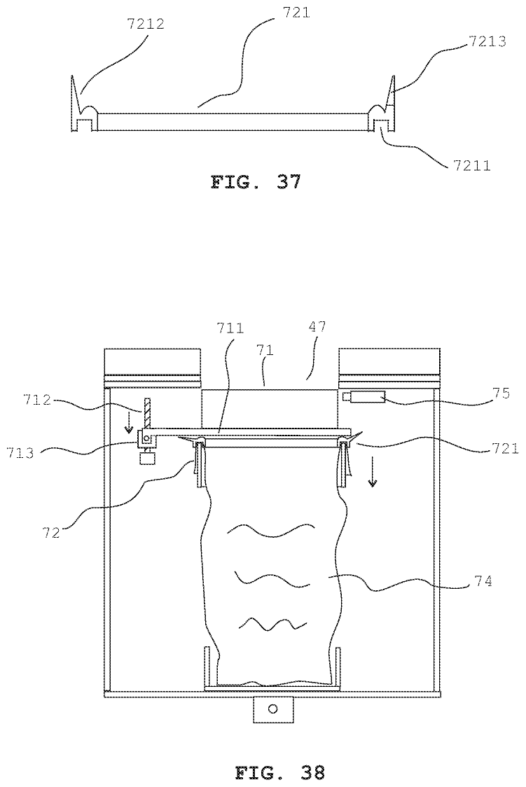

As illustrated in FIG. 37, fecal bag holder ring 721 is used to attach fecal bag 74 to fecal bag holder 72, to seal odor from fecal bag 74, and to prevent water from spilling into mobile body chamber 26 while cleaning, fecal bag holder ring 721 is made of soft elastic material such as silicon rubber, it has a mounting groove 7211, a water guarding wall 7212, and a cleaning tube opening 7213, mounting groove 7211 is located at the bottom and is made to the same size and shape of the top rim of fecal bag holder, and can be snapped into or removed from the top rim of fecal bag holder 72 with fecal bag 74 installed to fecal bag holder 72 inside out, water guarding wall is around the outer edge of fecal bag holder ring 721, it has a height and a cross section shape of triangle, and has a cleaning tube opening 7213 that allows the cleaning tube of cleaning device 75 to extend under bidet hole 47 for cleaning, water guarding wall 7212 stay in upright position when no force is applied to it, and it can be bended flat outward when force is applied to it, such that when fecal bag holder 72 is moved up by fecal bag holder screw jack 73 to make fecal bag holder ring 721 against the rear of bidet seat plate 711, water guarding wall is bended flat outward, bidet seat plate 711 serves as a lid for fecal bag 74, such that odor can be sealed by fecal bag holder ring 721 and bidet seat plate 711, when fecal bag holder move down a distance of the height of water guarding wall 7212, water guarding wall 7212 return to upright position, such that when the cleaning tube of cleaning device 75 extend under fecal hole 47 to do the cleaning, spilling water will be blocked by water guarding wall 7212.

FIG. 38-FIG. 46 illustrated a complete operation cycle of bidet system 7.

As illustrated in FIG. 38, in order for patient to use bidet system 7, bidet seat pad 714 first must be moved away from bidet hole 47, since bidet seat pad 714 has a thickness, bidet seat screw jack 712 first lower bidet seat turning device 713, together with bidet seat 71, straight down to a position where the top of bidet seat pad 714 is just outside the bottom edge of bidet hole 47, at the same time fecal bag holder screw jack 73 also lower fecal bag holder 72 downward, such that bidet seat pad 714 is moved out of bidet hole 47.

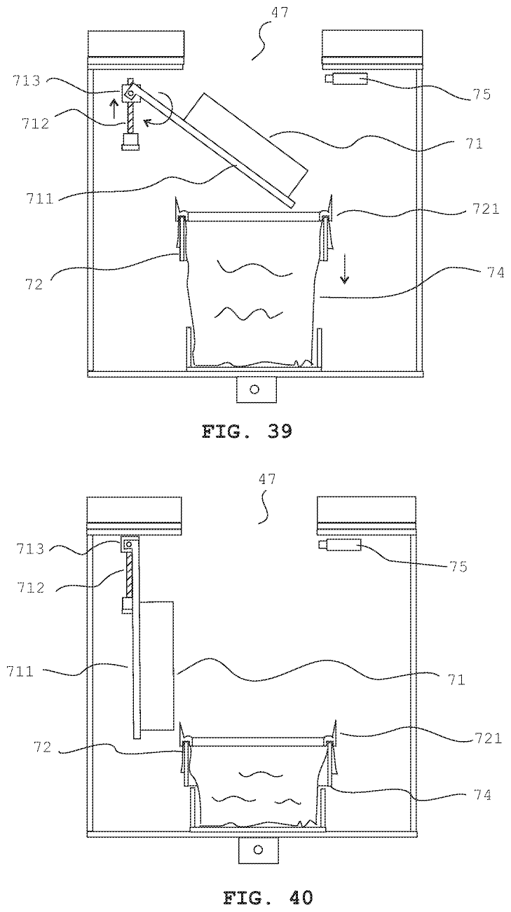

As illustrated in FIG. 39, when bidet seat pad 714 is just moved out of bidet hole 47, bidet seat turning device 713 begin to turn bidet seat plate 711 downward, and bidet seat screw jack 712 move bidet seat turning device 713 up, at the same time fecal bag holder screw jack 73 continue to lower fecal bag holder 72 downward to make room for bidet seat 71 to be turned to the side.

FIG. 40 illustrated the status in which fecal bag holder 72 is lowered to its lowest position, allows bidet seat 71 to be turned to the side.

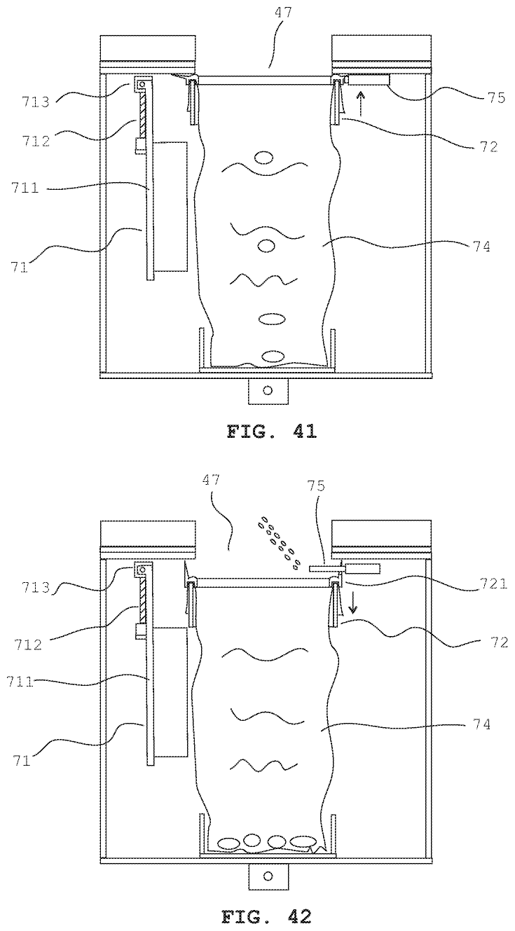

As illustrated in FIG. 41, after bidet seat 71 is turned to the side and stay at the side, fecal bag holder screw jack 73 move fecal bag holder 72 upward to reach the bottom edge of bidet hole 47, making bidet system 7 ready for patient to urinate or defecate, urine and feces are collected in fecal bag 74.

As illustrated in FIG. 42, after patient's urination or defecation is completed, bidet seat 71 stay at the side, fecal bag holder 72 is moved down a small distance by fecal bag holder screw jack 73 to make water guarding wall 7212 stay upright, allowing the washing tube and drying tube of cleaning device 75 to extend through cleaning tube opening 7213 and under fecal seat hole 47 to do the washing and drying.

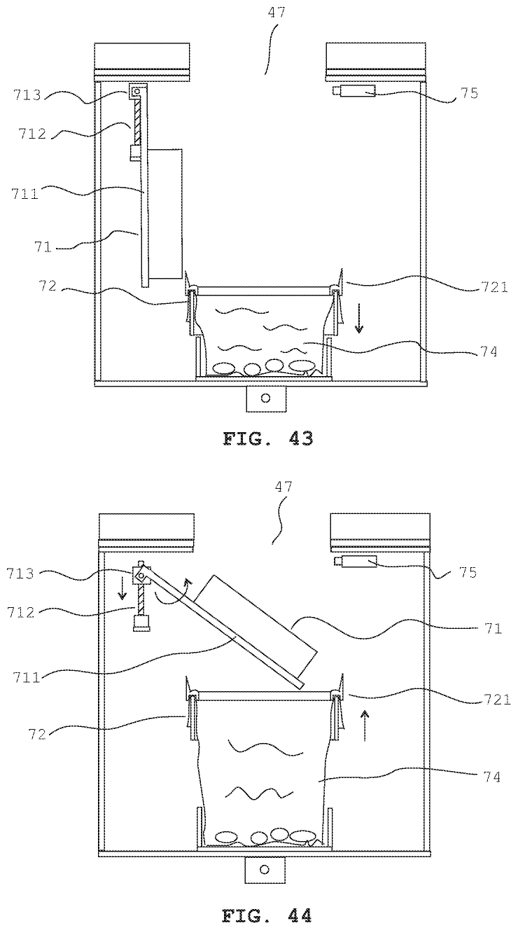

As illustrated in FIG. 43, after cleaning and drying are completed, fecal bag holder 72 is moved downward by fecal bag holder screw jack 73 to its lowest position again, making room for bidet seat turning device 713 to turn bidet seat 71 upward to reposition.

As illustrated in FIG. 44, as bidet seat 71 is turned upward to reposition, bidet seat screw jack 712 move bidet seat turning device 713 downward, and at the same time fecal bag holder screw jack 73 move fecal bag holder 72 upward.

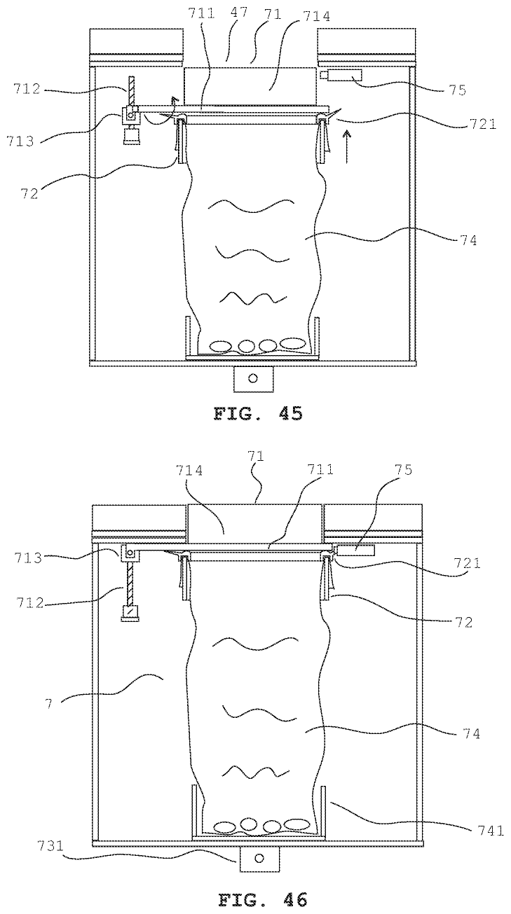

As illustrated in FIG. 45, when the top edge of bidet seat pad 714 reach the bottom edge of bidet hole 47, the top rim of fecal bag holder 72 also reach the rear of bidet seat plate 711.

As illustrated in FIG. 46, bidet seat screw jack 712 move bidet seat turning device 713 and bidet seat 71 upward, and at the same time fecal bag holder screw jack 73 continue to move fecal bag holder 72 upward, the combined force of bidet seat screw jack 712 and fecal bag holder screw jack 73 push bidet seat pad 714 through bidet hole 47 and reposition, water guarding wall 7212 is bended flat outward, and odor from fecal bag 74 is sealed by fecal bag holder ring 721 and bidet seat plate 711.

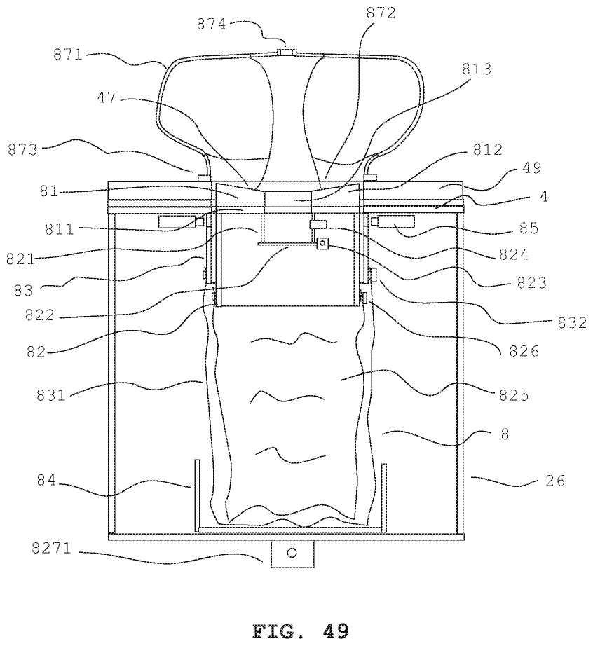

FIG. 47 illustrates the rear view of incontinence bidet system 8, FIG. 48 illustrates the side view of incontinence bidet system 8, FIG. 49 illustrates the cross section rear view of incontinence bidet system 8.

As illustrated in FIG. 47, FIG. 48 and FIG. 49, incontinence bidet system 8 comprises an incontinence bidet seat 81, an inner incontinence fecal bag holder 82, an inner incontinence fecal bag 825, an inner incontinence fecal bag holder screw jack 827, an outer incontinence fecal bag holder 83, an outer incontinence fecal bag 831, an incontinence fecal bag tray 84, an incontinence cleaning device 85, an incontinence water tank 86, and a butt retainer 87.

As illustrated in FIG. 47, FIG. 48 and FIG. 49, incontinence bidet seat 81 further comprises an incontinence bidet seat plate 811 and an incontinence bidet seat pad 812, incontinence bidet seat pad 812 has a thickness and is attached to the top of incontinence bidet seat plate 811, there is an incontinence fecal hole 813 locate in the middle portion of incontinence bidet seat 81, incontinence bidet seat pad 812 is positioned in bidet seat hole 47 when incontinence bidet system 8 is in ready to use mode; inner incontinence fecal bag holder 82 further comprises a fecal tube 821, the top of inner incontinence fecal bag holder 82 is affixed to the rear of incontinence bidet seat plate 811, with the top of fecal tube 821 connected to the bottom of incontinence fecal hole 813, the bottom of fecal tube 821 is covered with a fecal tube cover 822, fecal tube cover 822 can be opened or closed by a fecal tube cover opening device 823, fecal tube cover opening device 823 is controlled by a fecal sensor 824, inner incontinence bidet fecal bag holder 82 is mounted on inner incontinence fecal bag holder screw jack 827, and can be moved up or down by inner incontinence fecal bag holder screw jack 827, inner incontinence fecal bag holder screw jack 827 is driven by an inner incontinence fecal bag holder screw jack motor 8271, inner incontinence fecal bag 825 is a flexible plastic bag and can be attached to or released from inner incontinence fecal bag holder 82 by an inner incontinence fecal bag fastener 826, odor from inner incontinence fecal bag 825 is sealed by incontinence bidet seat plate 811 and incontinence fecal tube cover 822.

As illustrated in FIG. 47, FIG. 48 and FIG. 49, an outer fecal bag holder 83 and an outer fecal bag 831 is used to collect excrement and cleaning water that fall through the gap between bidet seat and thigh mattress pad 49, the top of outer incontinence fecal bag holder 83 is affixed to the rear of thigh base pate 41, outer incontinence fecal bag 831 is a flexible plastic bag and can be attached to or removed from outer incontinence fecal bag holder 83 by an outer incontinence fecal bag fastener 832, both inner incontinence fecal bag 825 and outer incontinence fecal bag 831 are supported by an incontinence fecal bag tray 84, incontinence cleaning device 85 is capable of washing and drying the private part of a patient and incontinence bidet seat pad 812, incontinence cleaning device 85 is connected to incontinence water tank 86 via water tube and get water supply from water tank 86.

For fecal incontinence patients, they may urinate or defecate in any position on the bed, to make sure they will urinate or defecate above bidet seat pad 812, it is necessary to retain patient's butt above incontinence bidet seat pad 812 and provide methods to clean incontinence bidet seat 81, as well as patient's private part from the above.

As illustrated in FIG. 47, FIG. 48 and FIG. 49, a briefs like butt retainer 87 is installed above bidet seat 81, butt retainer 87 is preferably made of water proof retainer fabric 871, butt retainer 87 has a bottom opening 872, the edge of bottom opening 872 can be attached to or removed from the edge of bidet hole 47 by retainer fastener 873, such that patient's butt can be retained above bidet seat 81 when they wear butt retainer 87, a retainer cleaning hole 874 is located on top of retainer 87 to allow caregiver to insert cleaning tube or dryer tube into retainer 87 to further clean and dry patient's butt and butt retainer 87 from the above, butt retainer 87 can be divided into several parts for easy setup and cleaning.

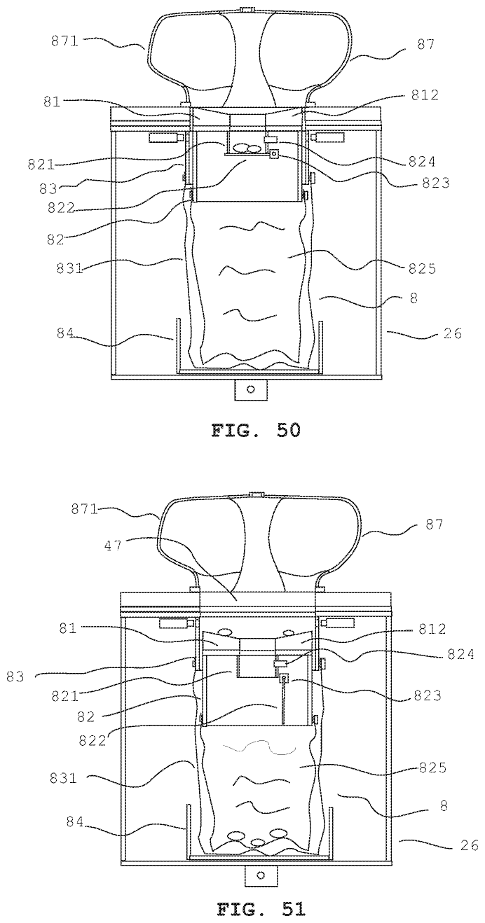

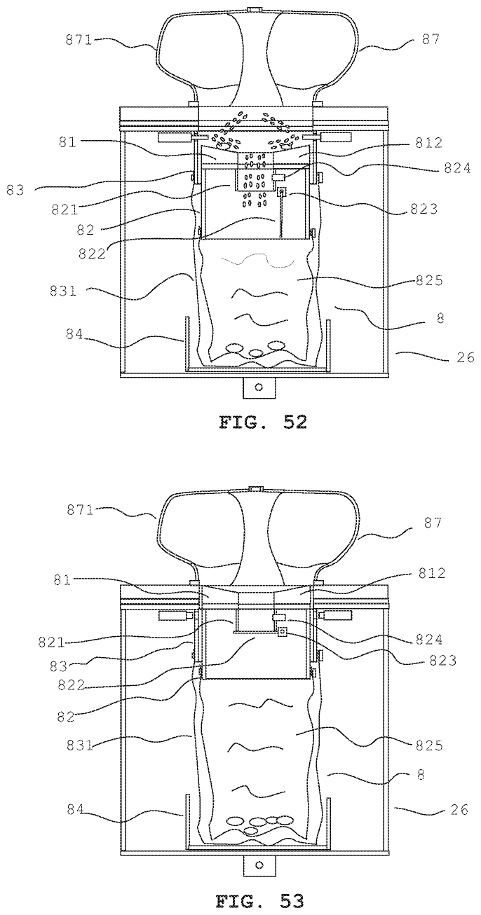

FIG. 50, FIG. 51, FIG. 52 and FIG. 53 illustrate a complete operation cycle of incontinence bidet system 8.

As illustrated in FIG. 50, when a fecal incontinence patient defecates or urinate, fecal sensor 824 detects the feces or urine and sends a signal to control system 12.

As illustrated in FIG. 51, control system 12 order inner incontinence fecal bag holder screw jack 827 to lower inner incontinence fecal bag holder 82, thus move incontinence bidet seat pad 812 out of bidet hole 47, at the same time control system 12 order fecal tube cover opening device 823 to open fecal tube cover 822 to allow feces or urine drop into inner fecal bag 825.

As illustrated in FIG. 52, after a preset time, the washing tube and drying tube of cleaning device 85 move in to wash and dry patient's private part and bidet seat pad 812, most washing water fall through fecal hole 813 and fecal tube 821 to inner incontinence fecal bag 825, washing water that fall through the gap between incontinence bidet seat 81 and bidet hole 47 fall into outer incontinence fecal bag 831.

As illustrated in FIG. 53, after patient's private part and bidet seat pad 812 are washed and dried, inner incontinence fecal bag holder 82 is moved up by inner incontinence fecal bag holder screw jack 827, making incontinence bidet seat 81 to reposition and ready for next defecation or urination.

### Other Embodiment

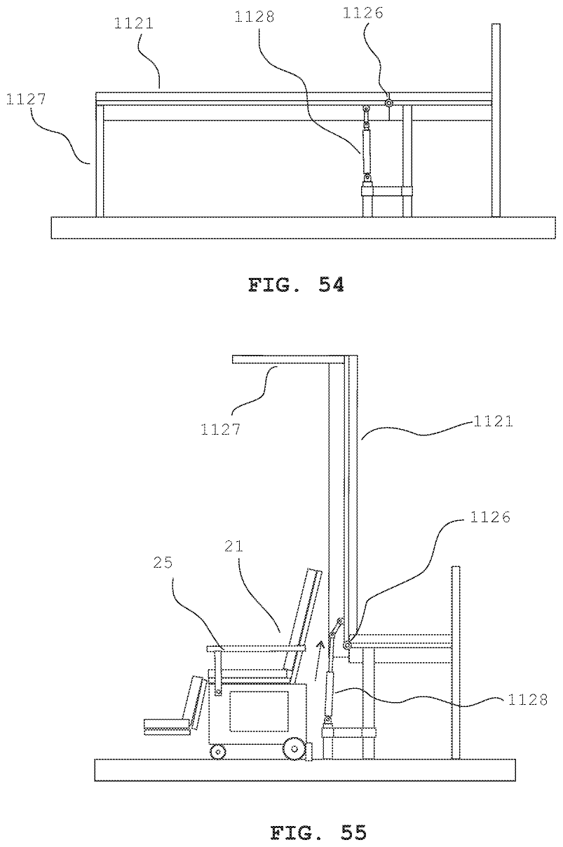

FIG. 54 and FIG. 55 illustrate another embodiment of the present invention, in which right rotatable side 1121 and left rotatable side 1122 are rotated upward to make room for rotatable armrest 25 to setup and for wheelchair 21 to move out and to return to bed body opening easily.

As illustrated in FIG. 54, right rotatable side 1121 is jointed to right stationary side 1112 with a first upward hinge 1126 and can be rotated upward by a first upward rotating device 1128, left rotatable side 1122 is jointed to left stationary side 1113 with a second upward hinge 1126 and can be rotated upward by a second upward rotating device 1128, upward hinges 1126 are positioned closer to stationary head 1111 than armrest rotatable arms 251, such that when right rotatable sides 1121 and left rotatable sides 1122 are rotated upward, armrest rotatable arms 251 have room to rotate upward to setup armrest 25 automatically.

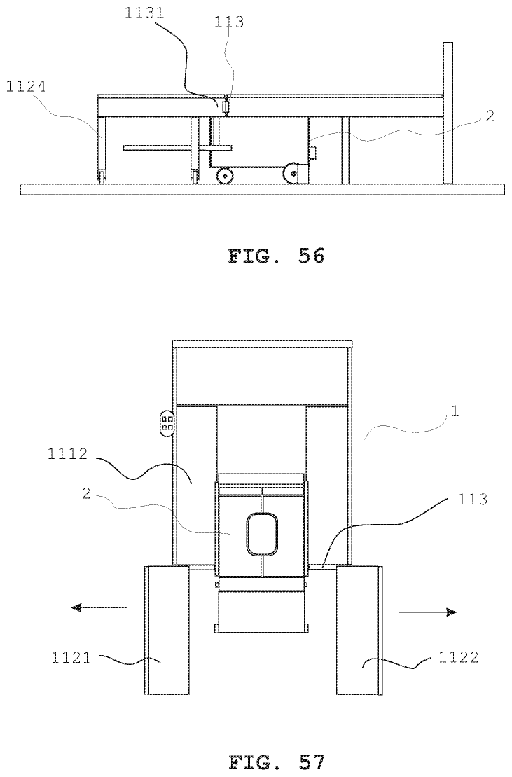

FIG. 56 and FIG. 57 illustrate another embodiment of the present invention, in which right rotatable side 1121 and left rotatable side 1122 are moved sideward to make room for rotatable armrest 25 to setup and for wheelchair 21 to move out and to return to bed body 11 easily.

As illustrated in FIG. 56 and FIG. 57, right rotatable side 1121 is jointed to right stationary side 1112 with a first side track 113, and can be moved to the right side by a first side moving device 1131 (not shown), left rotatable side 1122 is jointed to left stationary side 1113 with a second side track 113, and can be moved to the left side by a second side moving device 1131 (not shown), side tracks 113 are positioned closer to stationary head 1111 than armrest rotatable arms 251, such that when right rotatable side 1121 and left rotatable side 1122 are moved to the side, armrest rotatable arms 251 have room to rotate upward to setup armrest 25 automatically.

For bidet system 7, because there are gaps along the edge of bidet hole 47, to prevent urine spill into these gaps or over thigh plate mattress pad 49, it is necessary to block these urine spill.

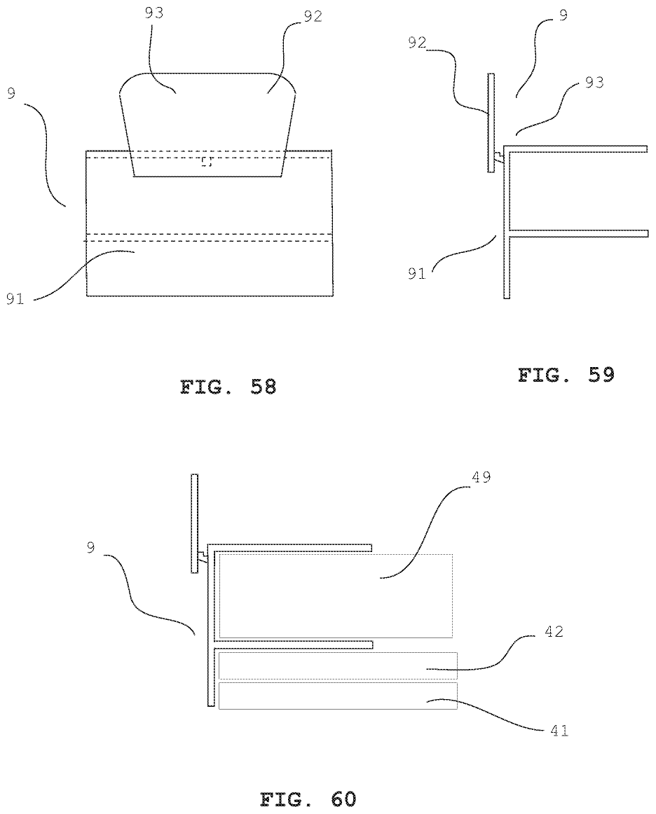

FIG. 58 illustrates the front view of urine guard 9, FIG. 59 illustrates the side view of urine guard 9, FIG. 60 illustrates the cross section side view of an installed urine guard 9, urine guard 9 is made of elastic material such as silicon rubber, it has a bottom urine blocking plate 91 and a top urine blocking plate 92, bottom urine blocking plate 91 can be attached or removed from thigh mattress pad 49, top urine blocking plate 92 is connected to the top of bottom urine blocking plate 91 with a stem 93, the bottom edge of top urine blocking plate 92 overlap the top edge of bottom urine blocking plate 91, top urine blocking plate 92 remain in upright position when no weight is put on it, and it will be bended down when a patient's body weight is put on it, when patient use the bidet system 7, the body weight move away, and top urine blocking plate 92 resume to upright position to block spilling urine.

For users who have difficulty control wheelchair 21, an navigation pilot system can be added to robotic care bed 1, such that patient can order electric wheelchair goes to a specific location or return to bed automatically.

Wheelchair 21 can be driven by electric if two of mobile body wheels 211 are replaced by two electric motor wheels 212.

Having thus disclosed a number of preferred embodiments of the present invention, it being understood that numerous modifications and additions are contemplated and will now be apparent to those having benefit of the above disclosure, what is claimed is:

1. A robotic care bed comprising a bed body, a mobile body, and a control system, said mobile body can be converted into a wheelchair automatically, said bed body and said mobile body can be automatically combined together or separated from each other by electromagnet means;
a) said bed body comprising a stationary part, a right rotatable side, a left rotatable side, an auto charging device, and a return guiding system, said stationary part further comprising a stationary head, a right stationary side, and a left stationary side, said stationary part, said right rotatable side and said left rotatable side form a bed body opening in the middle portion of said bed body to accommodate said mobile body, said auto charging device is capable of automatically charging said mobile body when said mobile body is parked in said bed body opening, said return guiding system is capable of guiding said wheelchair return to said bed body opening easily;
wherein a first wheeled leg is affixed to one end of said right rotatable side, the other end of said right rotatable side is jointed to said right stationary side with a first sideward hinge, said right rotatable side can be rotated to the right side by a first sideward rotating device, a second wheeled leg is affixed to one end of said left rotatable side, the other end of said left rotatable side is jointed to said left stationary side with a second sideward hinge, said left rotatable side can be rotated to the left side by a second sideward rotating device;
such that when said right rotatable side and said left rotatable side are rotated to the side, said bed body opening is enlarged, and a space is created for said mobile body to be converted into said wheelchair automatically, and for said wheelchair to move out or return to said bed body opening easily;
wherein at least one back plate electromagnet is affixed to the inner edge of said stationary head, at least one calf plate electromagnet is affixed to the inner edge of said right or left rotatable side, at least one feet plate electromagnet is affixed to the inner edge of said right or left rotatable side;
b) said mobile body comprising a double plate high/low and turn over structure, a calf plate, a feet plate, a calf and feet plate high/low device, a mobile body chamber, an auto armrest system, an auto bidet system, at least three mobile body wheels, a rechargeable battery, and a plurality of blanket blocking rollers;
wherein said double plate high/low and turn over structure comprising a back plate, a thigh plate, a back plate high/low and turn over device, and a thigh plate high/low and turn over device;
wherein said back plate comprising a back base plate and a back turn plate, said back turn plate is formed by at least a right back turn plate and a left back turn plate that jointed together by at least one back turn plate hinge, the whole or part of said back turn plate can be locked or unlocked with said back base plate by electromagnet means;
such that when said back plate need to be raised or lowered, said back turn plate is locked with said back base plate, when said back plate need to be turn over, said right back turn plate or said left back turn plate is unlocked with said back base plate;
wherein the high/low or turn over function of said back plate is operated by said back plate high/low and turn over device;
wherein said thigh plate comprising a thigh base plate and a thigh turn plate, said thigh turn plate is formed by at least a right thigh turn plate and a left thigh turn plate that jointed together by at least one thigh turn hinges, the whole or part of said thigh turn plate can be locked or unlocked with said thigh base plate by electromagnet means;
such that when said thigh plate need to be high/low, said thigh turn plate is unlocked with said thigh base plate, when said thigh plate need to be turn over, said right thigh turn plate or said left thigh turn plate is unlocked with said thigh base plate;
wherein the high/low or turn over function of said thigh plate is operated by said thigh plate high/low and turn over device;
wherein the high/low function of said calf plate and said feet plate is operated by said calf and feet plate high/low device;
wherein the bottom edge of said back base plate is jointed to the top edge of said thigh base plate with a first plate hinge, the bottom edge of said thigh base plate is jointed to the top edge of said calf plate with a second plate hinge, the bottom edge of said calf plate is jointed to the top edge of said feet plate with a third plate hinge;
wherein said thigh base plate is mounted on top said mobile body chamber, said back plate high/low and turn over device, said thigh plate high/low and turn over device, and said bidet system are housed in said mobile body chamber, said mobile body chamber is mounted on said mobile body wheels, said rechargeable battery is mounted in said mobile body chamber and can be automatically charged by said auto charging device, said rechargeable battery is capable of providing electric power to all electric parts in said mobile body;
such that said mobile body can be converted into a wheelchair or lay flat by said back plate high/low and turn over device and said calf and feet plate high/low device;
wherein two of said mobile body wheels can be electric motor wheels, such that said wheelchair can be driven by electric power;
wherein at least one back plate magnet locking piece is affixed to the outer edge of said back plate, in location corresponding to said back plate electromagnet when said mobile body is laid flat in said bed body opening; at least one calf plate magnet locking piece is affixed to the outer edge of said calf plate, in location corresponding to said calf plate electromagnet when said mobile body is laid flat in said bed body opening, at least one feet plate magnet locking piece is affixed to the outer edge of said feet plate, in location corresponding to said feet plate electromagnet when said mobile part is laid flat in said bed body opening;
such that when said mobile body is parked in said bed body opening and is laid flat, said back plate can be locked or unlocked by said back plate electromagnet, said calf plate can be locked or unlocked by said calf plate electromagnet, and said feet plate can be locked or unlocked by said feet plate electromagnet, such that said mobile body can be locked or unlocked with said bed body;
wherein said bidet system is housed in said chamber, said bidet system is capable of automatically collecting excrement from an user with a flexible fecal bag, said bidet system is capable of automatically cleaning the private part of said user, and automatically sealing odor from said fecal bag;
c) said control system is connected to said robotic care bed electronically and is capable of accepting orders from a person and instruct said robotic care bed to perform the necessary functions.

2. The high/low and turn over structure in claim 1 comprising a back plate, a back plate high/low and turn over device, a thigh plate, and a thigh plate high/low and turn over device;
a) said back plate comprising a back base plate and a back turn plate;
wherein a right back base plate electromagnet is affixed to the right side of said back base plate, a left back base plate electromagnet is affixed to the left side of said back base plate, at least one back base plate window is opened in said back base plate;
wherein said back turn plate comprising a right back turn plate, a left back turn plate, a right center back turn plate, and a left center back turn plate, said right back turn plate, said left back turn plate, said right center back turn plate, and said left center back turn plate are jointed together by a plurality of back turn plate hinges, a right back turn plate magnet locking piece is affixed to the rear of said right back turn plate, in a location corresponding to said right back base plate electromagnet, a left back turn plate magnet locking piece is affixed to the rear of said left back turn plate, in a location corresponding to said left back base plate electromagnet;
wherein said back plate is formed by placing said back turn plate on top of said back base plate, with said right back turn plate magnet locking piece locates above said right back base plate electromagnet, and said left back turn plate magnet locking piece locates above said left back base plate electromagnet;
such that when said right back base plate electromagnet and said left back base plate electromagnet are electrified, said back turn plate is locked with said back base plate into one piece;
such that when said right back base plate electromagnet is electrified and said left back base plate electromagnet is unelectrified, said left back turn plate, said left center back turn plate, and said right center back turn plate are unlocked from said back base plate and can be rotated around the back turn plate hinge that joint said right back turn plate and said right center back turn plate;
such that when said left back base plate electromagnet is electrified and said right back base plate electromagnet is unelectrified, said right back turn plate, said right center back turn plate, and said left center back turn plate are unlocked from said back base plate and can be rotated around the turn plate hinge that joint said left back turn plate and said left center back turn plate;
b) said back plate high/low and turn over device comprising a right back plate linear actuator, a left back plate linear actuator, a plurality of bottom back plate multi direction swivel, and a plurality of top back plate multi direction swivel;
wherein the bottom of said right back plate linear actuator is jointed to a first bottom back plate multi direction swivel, the extension tube of said right back plate linear actuator is extended through said back base plate window and is jointed to a first top back plate multi direction swivel, said first top back plate multi direction swivel is affixed to the rear of said right center turn plate, the bottom of said left back plate linear actuator is jointed to a second bottom back plate multi direction swivel, the extension tube of said left back plate linear actuator is extended through said back base plate window and is jointed to a second top back plate multi direction swivel, said second top back plate multi direction swivel is affixed to the rear of said left center turn plate;
c) said thigh plate comprising a thigh base plate and a thigh turn plate;
wherein a right thigh base plate electromagnet is affixed to the right side of said thigh base plate, a left thigh base plate electromagnet is affixed to the left side of said thigh base plate, there is at least one thigh base plate window opened in said thigh base plate;
wherein said thigh turn plate comprising a right thigh turn plate, a left thigh turn plate, a right center thigh turn plate, and a left center thigh turn plate, said right thigh turn plate, said left thigh turn plate, said right center thigh turn plate, and said left center thigh turn plate are jointed together by a plurality of thigh turn plate hinges, a right thigh turn plate magnet locking piece is affixed to the rear of said right thigh turn plate, in a location corresponding to said right thigh base plate electromagnet, a left thigh turn plate magnet locking piece is affixed to the rear of said left thigh turn plate, in a location corresponding to said left thigh base plate electromagnet;
wherein said thigh plate is formed by placing said thigh turn plate on top of said thigh base plate, with said right thigh turn plate magnet locking piece locate above said right thigh base plate electromagnet, and said left thigh turn plate magnet locking piece locate above said left thigh base plate electromagnet;
such that when said right thigh base plate electromagnet and said left thigh base plate electromagnet are electrified, said thigh turn plate is locked with said thigh base plate into one piece;
such that when said right thigh base plate electromagnet is electrified and said left thigh base plate electromagnet is unelectrified, said left thigh turn plate, said left center thigh turn plate, and said right center thigh turn plate are unlocked from said thigh base plate and can be rotated around the turn plate hinge that connect said right thigh turn plate and said right center thigh turn plate;
such that when said left thigh base plate electromagnet is electrified and said right thigh base plate electromagnet is unelectrified, said right thigh turn plate, said right center thigh turn plate, and said left center thigh turn plate are unlocked from said thigh base plate and can be rotated around the turn plate hinge that connect said left thigh turn plate and said left center thigh turn plate;
d) said thigh plate high/low and turn over device comprising a least one right thigh plate linear actuator, at least one left thigh plate linear actuator, a plurality of bottom thigh plate multi direction swivels, and a plurality of top thigh plate multi direction swivels;
wherein the bottom of said right thigh plate linear actuator is jointed to a first bottom thigh plate multi direction swivel, the extension tube of said right thigh plate linear actuator is extended through said thigh base plate window and is jointed to a first top thigh plate multi direction swivel, said first top thigh plate multi direction swivel is affixed to the rear of said right center thigh turn plate, the bottom of said left thigh plate linear actuator is jointed to a second bottom thigh plate multi direction swivel, the extension tube of said left thigh plate linear actuator is extended through said thigh base plate window and is jointed to a second top thigh plate multi direction swivel, said second top thigh plate multi direction swivel is affixed to the rear of said left center thigh turn plate;
wherein said thigh base plate is mounted on a platform, the top edge of said thigh base plate is jointed to the bottom edge of said back base plat with at least one plate hinge;
such that said back plate can be rotated around said plate hinge to form an angle with said thigh base plate;
such that when said double plate high/low and turn over structure receives an order to raise said back plate, said right back base plate electromagnet and said left back base plate electromagnet are electrified to lock said back turn plate with said back base plate into one piece, said right back plate linear actuator and said left back plate linear actuator extend at the same speed to the same distance, such that said back plate is rotated upward around said plate hinge to form a desired angle with said thigh plate;
such that when said double plate high/low and turn over structure receives an order to turn over to the right, said right back base plate electromagnet and said right thigh base plate electromagnet are electrified, said left back base plate electromagnet and said left thigh base plate electromagnet are unelectrified, such that said left back turn plate, said left center back turn plate, and said right center back turn plate are unlocked from said back base plate, such that said left thigh turn plate, said left center thigh turn plate, and said right center thigh turn plate are unlocked from said thigh base plate; such that when said left back plate linear actuator and said left thigh plate linear actuator extend a long distance, said right back plate linear actuator and said right thigh plate linear actuator extend a short distance, said back turn plate and said thigh turn plate are rotated to the right to a desired angle and curve;
such that when said double plate high/low and turn over system receives an order to turn over to the left, said left back base plate electromagnet and said left thigh base plate electromagnet are electrified, said right back base plate electromagnet and said right thigh base plate electromagnet are unelectrified, such that said right back turn plate, said right center back turn plate, and said left center back turn plate are unlocked from said back base plate, such that said right thigh turn plate, said right center thigh turn plate, and said left center thigh turn plate are unlocked from said thigh base plate; such that when said right back plate linear actuator and said right thigh plate linear actuator extend a long distance, said left back plate linear actuator and said left thigh plate linear actuator extend a short distance, said back turn plate and said thigh turn plate are rotated to the left to a desired angle and curve;
wherein said thigh plate high/low and turn over device comprising a front right thigh plate linear actuator, a rear right thigh plate linear actuator, a front left thigh plate linear actuator, a rear left thigh plate linear actuator, a plurality of bottom thigh plate multi direction swivels, and a plurality of top thigh plate multi direction swivels;
such that said thigh turn plate can be tilted to different directions, or go straight up by adjusting the extended distance of said front right thigh plate linear actuator, said rear right thigh plate linear actuator, said front left thigh plate linear actuator, and said rear left thigh plate linear actuator.

3. The auto armrest system in claim 1 comprising two rotatable armrests, each said rotatable armrest comprising a rotatable arm, an armrest bar, an armrest rotating device, an armrest locking piece, and an armrest lock;
wherein said armrest rotating device is installed on each side of said mobile body chamber, one end of said rotatable arm is connected to said armrest rotating device, another end of said rotatable arm is connected to said armrest bar perpendicularly, said armrest locking piece is affixed to the long end of said armrest bar, said armrest lock is affixed to the edge of said back plate, in a location corresponding to said armrest locking piece when said wheelchair is setup, said armrest lock can be electromagnet or mechanical;
wherein said rotatable armrests are installed in such way that when said mobile body is parked in said bed body opening and is laid flat, said rotatable arms are further away from said stationary head than said sideward hinges, such that when said right rotatable side and said left rotatable are rotated to the side, said armrest bars have room to be rotated upward for setting up;
wherein said rotatable armrest are installed in such way that when said mobile body is parked in said bed body opening and is laid flat, said armrest bars are held under said thigh plate by said rotatable arms;
such that when said control system receive an order to covert said mobile body into a wheelchair, said right rotatable side and said left rotatable side are rotated to the side by said side rotating devices, and said armrest rotating devices rotate said rotatable arms upward until said armrest bars parallel to said thigh plate, and making said armrest locking pieces move to the locations of said armrest locks, such that the long end of said armrest bars are locked with said back plate by said armrest locks, such that said armrests are automatically secured to said wheelchair.

4. The return guiding system in claim 1 comprising a return guiding rail and two return guiding laser pens, said return guiding rail is installed along said bed body opening and has a wide open entrance, each side of said entrance is installed with a return guiding laser pen, said return guiding laser pen can generates visible laser beam to indicate the location of said entrance to a wheelchair user, such that said wheelchair user can follow said laser beams to return to said bed body opening easily.

5. The calf and feet plate high/low device in claim 1 comprising a calf plate linear actuator, two calf plate joint swivels, a feet plate linear actuator, two feet plate joint swivels, and a feet plate linkage, the base of said calf plate linear actuator is affixed to the front of said mobile body chamber via a first calf plate joint swivel, the extension tube of said calf plate linear actuator is affixed to the rear of said calf plate via a second calf plate joint swivel, the base of said feet plate linear actuator is affixed to the rear of said calf plate via a first feet plate joint swivel, the extension tube of said feet plate linear actuator is affixed to the rear of said feet plate via a second feet plate joint swivel and said feet plate linkage, such that the high/low of said calf and feet plates can be controlled by the extended distance of said calf plate linear actuator and said feet plate linear actuator.

6. The blanket blocking roller in claim 1, comprising a roller spring and a roller fabric, said roller spring is affixed to the edge of said back base plate or said thigh base plate, one end of said roller fabric is affixed to the edge of said back turn plate or said thigh turn plate, another end of said roller fabric is affixed to said roller spring;
such that when said double plate high/low and turn over system is not in turn over mode, said roller fabric is rolled into said roller spring, when said turn plate is turn to the right or left, said roller fabric is pulled out from said roller spring by said turn plate, creating a shield to cover the opening between said base plate and said turn plate, thus preventing a blanket from falling into said opening.

7. The right stationary side and left stationary side in claim 1, said right stationary side is supported and operated by a first inner stationary side liner actuator and a first outer stationary side liner actuator, said first inner stationary side liner actuator is affixed to the rear inner edge of said right stationary side via a first joint swivel, said first outer stationary side liner actuator is affixed to the rear outer edge of said right stationary side via a second joint swivel, said left stationary side is supported and operated by a second inner stationary side liner actuator and a second outer stationary side liner actuator, in which said second inner stationary side liner actuator is affixed to the rear inner edge of said left stationary side via a third joint swivel, said second outer stationary side liner actuator is affixed to the rear outer edge of said left stationary side via a fourth joint swivel, such that when said back turn plate and said thigh turn plate turn to the right, said first inner stationary side liner actuator is extended a very short distance, and said first outer stationary side liner actuator is extended a longer distance, making said right stationary side to tilt toward the middle of said robotic care bed, such that an user can be prevented from sliding to the right side, it works the same way when said robotic care bed turn over to the left.

8. The right rotatable side and left rotatable side in claim 1, said right rotatable side is jointed to said right stationary side with a first upward hinge and can be rotated upward by a first upward rotating device, said left rotatable side is jointed to said left stationary side with a second upward hinge and can be rotated upward by a second upward rotating device, said upward hinges are positioned closer to said stationary head than said armrest rotatable arms, such that when said right rotatable side and said left rotatable side are rotated upward, said armrest rotatable arms have room to rotate upward to setup said armrests automatically.

9. The right rotatable side and left rotatable side in claim 1, said right rotatable side is jointed to said right stationary side with a first side track, and can be moved to the right side by a first side moving device, said left rotatable side is jointed to said left stationary side with a second side track, and can be moved to the left side by a second side moving device, said side tracks are positioned closer to said stationary head than said armrest rotatable arms, such that when said right rotatable side and said left rotatable side are moved to the side, said rotatable arms have room to rotate upward to setup said armrests automatically.

10. The mobile body and return guiding system in claim 1, said mobile body and return guiding system are installed with an automatic navigation system that is capable of automatically navigating said wheelchair to different locations and returning said wheelchair to said bed body opening.

11. A bidet system for use in a care equipment, said care equipment has a chamber to accommodate said bidet system, said chamber has a top panel, a bidet hole is opened in said top panel, said bidet system comprising a bidet seat, a fecal bag holder, a fecal bag holder ring, a fecal bag holder moving device, a fecal bag, a cleaning device, a water tank, and a urine guard;
a) said bidet seat comprising a bidet seat plate, a bidet seat moving device, a bidet seat turning device, and a bidet seat pad, said bidet seat pad has a thickness and is attached to the top of said bidet seat plate, said bidet seat pad is positioned in said bidet hole when said bidet system is not in use, one end of said bidet seat plate is connected to said bidet seat turning device, said bidet seat turning device is mounted on said bidet seat moving device;
such that said bidet seat can be moved up or down by said bidet seat moving device, and can be turned by said bidet seat turning device;
b) said fecal bag holder is a little smaller than said bidet seat plate, said fecal bag holder is mounted on said fecal bag holder moving device, and is positioned right under said bidet hole, and can be moved up or down by said fecal bag holder moving device;
c) said fecal bag holder ring is made from elastic material and can be mounted on the top rim of said fecal bag holder;
d) said fecal bag is a flexible plastic bag and can be attached to or removed from said fecal bag holder, and is capable of holding liquid waste;
such that when said fecal bag holder is moved up by said fecal bag holder moving device to against the rear of said bidet seat plate, said bidet seat plate serves as a lid for said fecal bag, odor from said fecal bag can be sealed by said bidet seat plate and said fecal bag holder ring;
e) said cleaning device has a washing unit and a drying unit and is capable of cleaning and drying the private part of an user, said cleaning device is connected to said water tank via a water tube and get water supply from said water tank;
f) said urine guard can be installed at the edge of said bidet hole and is capable of preventing urine from spilling into and over said bidet hole;
such that when said bidet system receive an user's order of defecation or urination, said bidet seat turning device, together with said bidet seat are lowered by said bidet seat moving device, at the same time said fecal bag holder is lowered by said fecal bag holder moving device, such that said bidet seat is moved out of said bidet hole;
such that when said bidet seat is just moved out of said bidet hole, said bidet seat turning device begin to rotate said bidet seat plate downward, and said bidet seat moving device move said bidet seat turning device upward, at the same time said fecal bag holder moving device continue to move said fecal bag holder downward to make room for said bidet seat to be rotated to the side, after said bidet seat is rotated to the side, said fecal bag holder moving device move said fecal bag holder upward to reach the bottom edge of said bidet hole, ready for said user to urinate or defecate, urine and feces are collected in said fecal bag;
such that after said user's urination or defecation is completed, said bidet seat stay at the side, said washing unit and said drying unit move in to do the cleaning and drying, waste water is collected in said fecal bag, after cleaning is completed, said fecal bag holder is moved downward by said fecal bag holder moving device to make room for said bidet seat to be rotated upward to reposition;
such that when said bidet seat plate is rotated upward by said bidet seat turning device to reposition, said bidet seat turning device is moved downward by said bidet seat moving device, at the same time said fecal bag holder is moved upward by said fecal bag holder moving device;
such that when said bidet seat pad is rotated to a level position and just outside said bidet hole, the rotation of said bidet seat stop, the top rim of said fecal bag holder reach the rear of said bidet seat plate, said bidet seat turning device and said bidet seat plate are continue to be moved upward by said bidet seat moving device, and at the same time said fecal bag holder continue to be moved upward by said fecal bag holder moving device, such that said bidet seat is pushed through said bidet hole and reposition by the force of said bidet seat moving device and said fecal bag holder moving device, such that said fecal bag holder ring is pushed against the rear of said bidet seat plate to provide seal for said fecal bag to prevent odor.

12. The fecal bag holder ring in claim 11 is made of soft elastic material such as silicon rubber, it has a mounting groove, a water guarding wall, and a cleaning tube opening, said mounting groove is located at the bottom of said fecal bag holder ring and is made to the same size and shape of the top rim of said fecal bag holder, and can be snapped into or removed from the top rim of said fecal bag holder, said water guarding wall is around the outer edge of said fecal bag holder ring, said water guarding wall stay in upright position when no force is applied to it and can be bended outward when force is applied to it, said cleaning tube opening is opened in said water guarding wall to allow said washing unit and drying unit of said cleaning device to extend under said bidet hole for cleaning;
such that said fecal bag can be attached or removed from the top rim of said fecal bag holder by said fecal bag holder ring;
such that when said fecal bag holder is moved up to against the rear of said bidet seat plate, said water guarding wall is bended outward, said bidet seat plate serves as a lid for said fecal bag, said fecal bag holder ring serves as an odor sealing ring;
such that when said fecal bag holder move down a distance of the height of said water guarding wall, no force is applied to said water guarding wall, said water guarding wall return to upright position to prevent water from spilling into said chamber while cleaning.

13. The urine guard in claim 11 is made of elastic material such as silicon rubber, it has a bottom urine blocking plate and a top urine blocking plate, said bottom urine blocking plate can be attached or removed from the edge of said bidet hole, said top urine blocking plate is connected to the top edge of said bottom urine blocking plate with a stem;
such that said top urine blocking plate remain in upright position when no weight is put on it, and it will be bended down when a weight is put on it;
such that when an user use said bidet system, the body weight of said user move away from said urine guard, said top urine blocking plate return to upright position to prevent urine from spilling over the top of said bidet hole, and said bottom urine blocking plate can prevent urine from spilling into the edge of said bidet hole.

14. An incontinence bidet system for use in a care equipment, said care equipment has a chamber to accommodate said incontinence bidet system, said chamber has a top panel, a bidet hole is opened in said top panel, said incontinence bidet system comprising an incontinence bidet seat, an inner incontinence fecal bag holder, an inner incontinence fecal bag holder moving device, an inner incontinence fecal bag, an outer incontinence fecal bag holder, an outer incontinence fecal bag, an incontinence cleaning device, an incontinence water tank, and a butt retainer;
a) said incontinence bidet seat comprising an incontinence bidet seat plate and an incontinence bidet seat pad, said incontinence bidet seat pad has a thickness and is attached to the top of said incontinence bidet seat plate, an incontinence fecal hole is opened in the middle portion of said incontinence bidet seat, said incontinence bidet seat pad is positioned in said bidet hole when said incontinence bidet system is not in use;
b) said inner incontinence fecal bag holder is a little smaller or the same size of said incontinence bidet seat plate, said inner incontinence fecal bag holder comprising a fecal tube, the top of said inner incontinence fecal bag holder is affixed to the rear of said incontinence bidet seat plate, with the top of said fecal tube connected to the bottom of said incontinence fecal hole, the bottom of said fecal tube is covered with a fecal tube cover, said fecal tube cover can be opened or closed by a fecal tube cover opening device, said fecal tube cover opening device is controlled by a fecal sensor, said inner incontinence fecal bag holder is mounted on said inner incontinence fecal bag holder moving device, and can be moved up or down by said inner incontinence fecal bag holder moving device;
c) said inner incontinence fecal bag is a flexible plastic bag and can be attached to or removed from said inner incontinence fecal bag holder by an inner incontinence fecal bag fastener, said inner incontinence fecal bag is capable of holding liquid waste, odor from said inner incontinence fecal bag is sealed by said incontinence bidet seat plate and said incontinence fecal tube cover;
d) said outer incontinence fecal bag holder is larger than said inner incontinence fecal bag holder and said bidet hole, the top of said outer incontinence fecal bag holder is affixed to the rear of said top panel;
e) said outer incontinence fecal bag is a flexible plastic bag and is larger than said inner incontinence fecal bag, said outer incontinence fecal bag can be attached to or removed from said outer incontinence fecal bag holder by an outer incontinence fecal bag fastener, and is capable of holding liquid waste;
such that excrement and cleaning water that fall through the gap between said incontinence bidet seat and said top panel is collected in said outer incontinence fecal bag;
f) said incontinence cleaning device is capable of washing and drying the private part of an user and said incontinence bidet seat pad, said incontinence cleaning device is connected to said incontinence water tank via a water tube and get water supply from said incontinence water tank;
g) said butt retainer is briefs like and is preferably made of water proof fabric, said butt retainer is installed above said bidet hole, said butt retainer has a bottom opening, the edge of said bottom opening can be attached to or removed from the edge of said bidet hole by a retainer fastener, a retainer cleaning hole is opened on top of said butt retainer to allow caregiver to insert washing tube or dryer tube into said butt retainer for cleaning and drying, said butt retainer can be divided into several pieces for easy setup and cleaning;
wherein the size of said butt retainer is large enough for an user to sit up or turn over freely in bed;
such that when an user wear said butt retainer, said user's butt is retained above said incontinence bidet seat, and said user is still free to sit up or turn over in bed;
such that when an user defecates, said fecal sensor detects the feces and sends a signal to order said inner incontinence fecal bag holder moving device to lower said inner incontinence fecal bag holder, thus move said incontinence bidet seat pad out of said bidet hole, at the same time to order said fecal tube cover opening device to open said fecal tube cover to allow feces drop into said inner fecal bag;
such that after a preset time, the washing unit and drying unit of said cleaning device move in to wash and dry said user's private part and said bidet seat pad, waste water that fall through said fecal hole and said fecal tube is collected in said inner incontinence fecal bag, waste water that fall through the gap between said incontinence bidet seat and said bidet hole fall is collected in said outer incontinence fecal bag;
such that after user's private part and said bidet seat pad are washed and dried, said inner incontinence fecal bag holder is moved up by said inner incontinence fecal bag holder moving device, such that said incontinence bidet seat pad is pushed into said bidet hole to reposition.
